(19) United States
(12) Patent Application Publication
(10) Pub. No.: US 2025/0164620 A1
(43) Pub. Date: May 22, 2025

(54) Emulating Frequency-Modulated Continuous Wave (FMCW) Light Detection and Ranging (LiDAR) Targets using Optical IQ Modulation

(71) Applicant: NATIONAL INSTRUMENTS CORPORATION, Austin, TX (US)

(72) Inventors: Marcus Kieling daSilva, Leander, TX (US); Edward Benjamin Loewenstein, Austin, TX (US); Virginio Sannibale, Cedar Park, TX (US); Lee Haley Johnston, Austin, TX (US); Andy Kerr, Austin, TX (US); Abhishek Narendra Sharma, Bangalore (IN); Caleb Michael Harris, Round Rock, TX (US)

(21) Appl. No.: 18/513,023

(22) Filed: Nov. 17, 2023

(51) Int. Cl. G01S 7/497; G01S 7/481; G01S 7/4911; G01S 17/89

(52) U.S. Cl. CPC G01S 7/497; G01S 7/4818; G01S 7/4911; G01S 17/89

(57) ABSTRACT

A system for emulating an over-the-air environment for testing a Frequency-modulated Continuous Wave (FMCW) light detection and ranging (LiDAR) unit under test (UUT). The system includes an optical lens system that receives an FMCW laser signal from the LiDAR UUT, and provides the signals to one or more optical fibers. A slope, chirp timing and intensity of the FMCW laser signal is determined using digital signal processing, and a modulation waveform is determined to emulate an over-the-air (OTA) environment based at least in part on the slope, chirp timing, and intensity. An in-phase quadrature phase (IQ) modulator modulates the FMCW laser signal using the modulation waveform and provides the modulated laser signal back through the optical lens system to the LiDAR UUT.

### FIELD OF THE INVENTION

The present disclosure relates to the field of test, and more particularly to a system for emulating an over-the-air environment for testing a light detection and ranging (LiDAR) system.

### DESCRIPTION OF THE RELATED ART

Light Detection and Ranging (LiDAR) is a method for detecting objects, targets, and even whole scenes by shining a light on a target and processing the light that is reflected. LiDAR is, in principle, very similar to radar. The difference is that LiDAR uses light with a wavelength outside the radio or microwave bands to probe the target. Typically, infrared light is used, but other frequencies are also possible. The much smaller wavelengths allow LiDAR to have better spatial resolution than radar, allowing it to represent whole scenes as point clouds. Unlike a photographic image, which maps intensity and color onto 2 dimensions, each point in the LiDAR point cloud may additionally have an associated distance and/or velocity.

A typical LiDAR unit uses lasers to emit light. These emissions are scanned over the field of view and reflected by any objects in their path. The reflected light is received and processed by the LiDAR unit. Measurements (amplitude, delay, Doppler shift, etc.) of the received light as well as the scan angles (ϕ, θ) are aggregated, creating a physical description of the objects in the LiDAR's field of view. This method can represent a scene as a cloud of points as shown in FIG. 1. Each point in the cloud may have the following attributes:
Horizontal angle or azimuth (typically denoted by ϕ)
Vertical angle or elevation (typically denoted by θ)
Distance from the LiDAR unit. This is typically done by measuring the delay required for the light to make a round trip to the object and back.
Speed relative to the LiDAR unit. This may be measured in two ways:
   Doppler shift of the reflected light.
   Computing the change in detected distance over successive distance measurements.
Reflectivity. This is the fraction of the incident light that is reflected by the object, sometimes referred to as “intensity”.

Developers and manufacturers of LiDAR units as well as the makers of the vehicles on which they will be mounted (cars, aircraft, etc.) often need to test the LiDAR under various conditions. Currently developers and manufacturers typically resort to either: 1) testing in outdoor environments or 2) building a physical model of a real-world environment in a large area. While this can provide a well-defined test environment, it is large, expensive, difficult to automate and not scalable. Therefore, improvements in the field are desirable.

### SUMMARY OF THE INVENTION

Embodiments are presented herein of a system and method for performing light detection and ranging (LiDAR) test and target emulation. More specifically, embodiments relate to a system for emulating an over-the-air (OTA) environment for testing and/or calibrating a frequency-modulated continuous wave (FMCW) LiDAR unit under test.

In some embodiments, the system includes an optical lens system that receives an FMCW laser signal from the LiDAR UUT and provides the signals to an optical guidance system (such as one or more optical fibers). The slope, chirp timing, and intensity of the FMCW laser signal may be determined using analog or digital signal processing.

In some embodiments, a modulation waveform is determined in order to emulate an over-the-air (OTA) environment based at least in part on the determined slope, chirp timing, and intensity of the FMCW laser signal. The emulated OTA environment may include one or more targets and/or a propagation environment. An in-phase/quadrature (IQ) modulator modulates the FMCW laser signal using the modulation waveform and provides the modulated laser signal back through the optical lens system to the LiDAR UUT.

Other aspects of the present invention will become apparent with reference to the drawings and detailed description of the drawings that follow.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of a frequency-modulated continuous wave (FMCW) LiDAR system, according to some embodiments;

FIGS. 2A-B show up-down linear frequency-modulation (FM) ramps, according to some embodiments;

FIG. 3 illustrates an example of a Fourier transform of a received waveform with multiple reflectors, according to some embodiments;

FIG. 4 illustrates the frequency difference between transmitted and received linear FM ramps, according to some embodiments;

FIG. 5 is a block diagram of a LiDAR scene emulator for FMCW LiDARs including an input/output lens system, according to some embodiments;

FIG. 6 illustrates an example FMCW LiDAR environment emulation system utilizing digital signal processing, according to some embodiments;

FIG. 7 illustrates an optical processing block of an FMCW LiDAR environment emulation system, according to some embodiments;

FIG. 8 is a flowchart diagram illustrating a method for an emulator system to emulate an over-the-air environment for testing an FMCW LiDAR UUT, according to some embodiments;

FIG. 9 illustrates one or more photodetectors in an array used to detect laser scan position, according to some embodiments;

FIG. 10 illustrates an FMCW LiDAR environment emulation system with multiple optical processing chains, according to some embodiments;

FIGS. 11A-B illustrates systems utilizing a frequency-shifting interferometer to perform frequency discrimination, according to some embodiments;

FIG. 12A is a plot illustrating a determined discriminator frequency vs. time, according to some embodiments;

FIG. 12B is a plot illustrating laser frequency deviation vs. time, according to some embodiments;

FIG. 13 is a schematic diagram of an example system of a frequency discriminator using optical fibers with two photodetectors, according to some embodiments;

FIG. 14 is a schematic diagram of an example system of a frequency discriminator using optical fibers with a single photodetector, according to some embodiments;

FIG. 15 illustrates measurements used to determine the sign of the chirp slope, according to some embodiments;

FIG. 16 illustrates an optical system designed to place a scanning light beam into an optical fiber, according to some embodiments;

FIG. 17 illustrates a tapered optical fiber that may be used to increase the amount of light collected into the fiber, according to some embodiments;

FIG. 18 illustrates a lens and fiber-optic cable system including multiple paths, according to some embodiments;

FIG. 19 illustrates a system including a bundle of optical fibers configured to collect light from a wide field of view, according to some embodiments; and

FIG. 20 illustrates a system diagram of an optical train of an emulator combined with a beam characterization system, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

### LiDAR Test Systems

Modern LiDAR systems use modulated signals to sense the target environment. Testing these LiDAR units often involves emulating the effect that a target has on the optical waveforms transmitted by the LiDAR. Attributes of LiDAR emulation may include the distance to an object, which may be emulated by a time delay equal to the round-trip signal travel time at the speed of light. This time delay may be emulated by delaying the timing of the laser light that is returned to the LiDAR unit being tested. In addition, moving objects impart a frequency shift due to the Doppler effect. This frequency shift may be emulated by shifting the frequency of the laser light that is returned to the LiDAR unit being tested. In addition, targets with oblique or irregular surfaces may additionally spread the spectrum of the returned signal, each in a particular way. This spectrum spreading may be emulated by manipulating the spectrum of the laser light that is returned to the LiDAR unit being tested.

In some deployments, it may be desirable to emulate an actual physical environment. In this case, the distance, doppler effects, and surfaces effects from an actual scene or target may be determined and applied as a signature of the scene or target by the emulator.

Prior approaches for emulating targets for modulated LiDAR testing include distance emulation using physical delays. For example, delay lines may be implemented using lengths of coaxial cable, lengths of fiber-optic cable, multiple reflectors, etc. Velocity emulation may be accomplished using several methods of frequency shifting to emulate the Doppler effect. These may include single sideband (SSB) mixing, phase locked loops, serrodyne phase modulation, and others. Emulation of surface effects and oblique surfaces may be performed using actual standard surfaces, with controlled reflectivity and roughness, either angled or orthogonal to the LiDAR beam. Multiple reflections may be emulated by repeating each of the previous methods for distance, Doppler and surface effects.

These prior art approaches require expensive hardware and do not scale well with multiple LiDAR beams, multiple returns, or complex environment emulation. Embodiments described herein improve on these methods by providing systems and methods for emulating the optical environment observed by a LiDAR via digital signal processing. More specifically, embodiments described herein may provide developers and manufacturers of LiDAR units a means to emulate the optical environment observed by a LiDAR that is small, easy to replicate, and controllable by a computer.

There are three prevailing types of LiDAR that are currently commercially available or in development. Each comes with its own emulation challenges: 1) Signal time-of-flight (ToF) LiDARs; 2) LiDARs that use a series of linear FM Chirps, or frequency-modulation continuous wave (FMCW); and 3) flash LiDARs. Embodiments herein present systems and methods for emulating the optical environment for FMCW LiDAR, or potentially for other types of LiDAR that may be developed in the future.

### LiDAR Scene Emulation

The job of a LiDAR emulator is to receive the signals transmitted by a LiDAR under test (LUT) and return signals back to the LUT in such a way that the LUT cannot distinguish them from the return signals created by the environment. Additionally, it is desirable for the emulator to be small, inexpensive, and programmatically controlled, allowing for the emulation of many moving objects, impairments (sunlight, dust, snow, other LiDARs, etc), and environments. Some attributes of a LiDAR emulator include:

1) The Field of view (FOV) is the view area that the LUT is able to map in 3 dimensions. It is often defined using the horizontal and vertical (ϕ, θ) angles over which the LUT creates an image. The symbol ϕ represents the horizontal angle range, which may range from 30 to 360 degrees for automotive LiDAR applications. The symbol θ represents the vertical angle, which may vary in various ranges, e.g., from −10 to +80 degrees, from 10 to 90 degrees, etc., for automotive LiDAR applications. An emulator may create scenes covering all or a part of the FOV.

2). The Angular resolution, which is the is the smallest angle that a LiDAR can detect. The vertical and horizontal angular resolutions may be of the order of 0.1 degrees, as one example.

3). Number of points in the point cloud. Automotive LiDARs typically depict scenes with 1,000 to over 1,000,000 points, although other numbers of points are also possible.

4). Minimum/maximum distance. Automotive LiDARs may function for distances of 1 m to about 1 km, although other distance ranges may become usable in the future.

Minimum/maximum velocity of emulated objects. Automotive LiDARs may measure speeds ranging from 0 to 500 km/hour.

5). Emulating the effects of impairments such as dust, rain, sunlight, other LiDARs, etc.

6). Dynamic scenes describe the ability to change a scene from frame to frame. LiDARs may have frame rates of 10 to 100 frames per second.

7) Emulator Size. Automotive LiDARs are designed to see a large field of view over distances as large as 1000 meters. Other LiDAR applications may reach even farther. The ideal emulator occupies a small fraction of this space, allowing it to be placed on a bench, factory floor, or on a production line.

8). Point cloud. LiDARs may map an environment with 1,000 to 1,000,000 (or more) points within a point cloud. The point cloud represents the set of points that describe the features of the environment to a predetermined level of detail or resolution. Each point in the point cloud has the azimuth (Φ) and elevation (θ) angles, reflectivity, distance and Doppler shifts of the targets. Accordingly, each point in the point cloud may be up to a five-dimensional quantity, with one dimension specifying each of the previously listed parameters. Additional attributes may be assigned to each point including scan number, time stamps, statistical quantities, etc. Scanning LiDARs may take advantage of sequential nature of a scan to time share the electronic and optical processing elements.

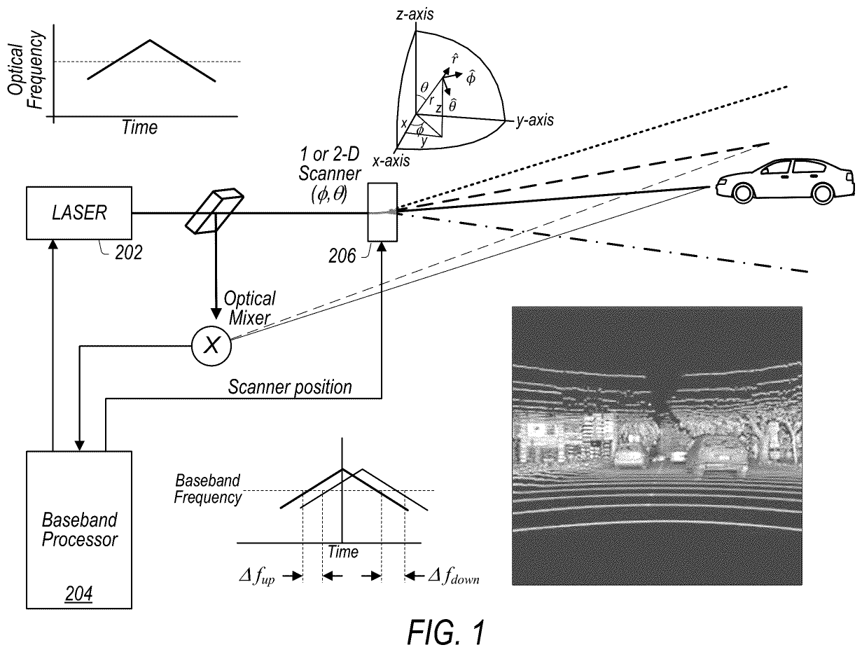

### FIG. 1: FMCW LiDAR

FIG. 1 shows a simplified schematic of a FMCW LiDAR system. FMCW LiDAR uses linear frequency-modulation of the laser light and synchronous processing at the receiver. Not only are FMCW LiDARs more resistant to interference than their ToF counterparts, but they utilize less peak optical power to obtain comparable range and sensitivity.

The FMCW LiDAR may use the following basic functional blocks to render a scene:

1) Frequency-modulated laser source. Similar to TOF LiDAR, the laser in a FMCW LiDAR also produces light signals. The signals, however, are of longer duration and lower amplitude compared to those for ToF LiDARs and they are frequency-modulated with a linear ramp or frequency sweep. Many FMCW LiDARs use a combination of linear up-ramp and a linear down-ramp in the frequency sweep. The linear frequency sweeps allow several signal processing advantages over ToF LiDARs, as explained in greater detail below.

2). Linear frequency sweep processing. The linear frequency sweep means that the frequency of the emitted laser light changes linearly in time. The laser is reflected by a target and experiences a round-trip time delay. This time delay means that (for a stationary reflector) the frequency of the received signal is the same as the frequency that was transmitted at an earlier time, before the time delay. The received signal interferes with the transmitted signal via optical mixing and the resulting baseband signal is processed electronically.

The Doppler effect is a well understood consequence of moving objects that transmit and receive waves. When a transmitter and receiver are moving closer to each other, the receiver detects a frequency that is increased by an amount that is proportional to the velocity. Receivers and transmitters that are moving apart from the transmitter will detect a frequency that is lower by an amount proportional to the separation velocity.

$${f}_{R} = \frac{C + {V}_{R}}{C + {V}_{T}} {f}_{T} , \qquad ( 1 )$$

where f_{R} is the received frequency, V_{R} is the receiver velocity, f_{T} is the transmitted frequency, and V_{T} is the transmitter velocity. When the velocity is small relative to the speed of light we can approximate Equation (1) by

$$Δ {f}_{Doppler} = \frac{{V}_{R} - {V}_{T}}{C} {f}_{T} , \qquad ( 2 )$$

where Δf_{Doppler} is the frequency shift due to the relative velocity between transmitter and receiver.

Up-ramp refers to where the received frequency is lower than the transmitted frequency for a stationary object. Down-ramp refers to where the received frequency is higher than the transmitted frequency for a stationary object. If the target object is moving relative to the LiDAR unit then the received signal also experiences a frequency shift due to the Doppler effect, which is independent of sweep direction. The effects of transit delay and the Doppler shift can be separated by processing the up and down-ramps together. The frequency shift in the up-ramp contains the effect of Doppler minus the effect of the delay. The frequency shift in the down-ramp contains the effect of Doppler plus the effect of delay.

Accordingly, the effect of the Doppler shift may be separated from the effect of the round-trip time delay, such that the FMCW LiDAR system may calculate both the velocity of and the distance to the reflective point in the scene.

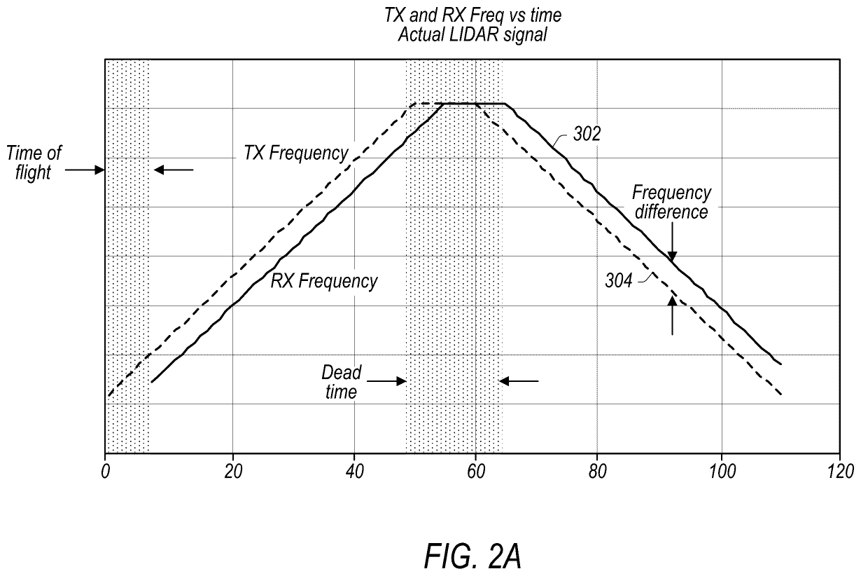

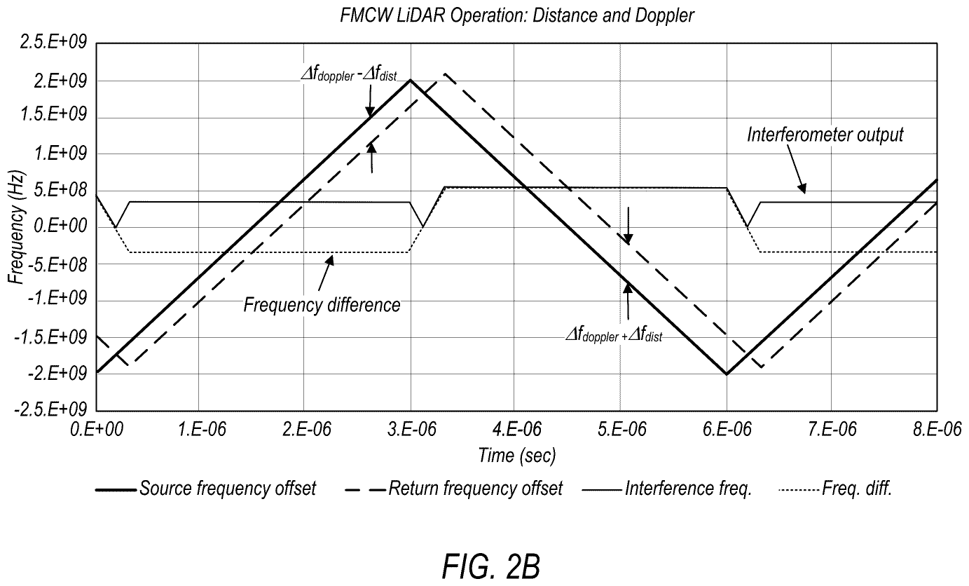

### FIGS. 2A-B: Up-Down Linear FM Ramp

FIG. 2A shows a graph of the transmit (TX) and receive (RX) frequency vs. time of an actual LiDAR signal, where the frequency is modulated by a linear ramp. Each up- and down-ramp may have a time duration longer than the maximum round trip transit time. The received signal may be a delayed version of the transmitted signal, where a delayed receive signal is combined with a current transmitted signal. In the up-ramp, the delay causes the RX frequency to be lower than the TX frequency. In the down-ramp, the delay causes the RX frequency to be higher than the TX frequency. Speed may also cause a frequency shift due to the Doppler effect. For example, frequency shifts up when the target is approaching, and frequency shifts lower when the target is receding.

Both transit time and the Doppler effect may create a frequency shift. This frequency shift is recovered when the received light signal is mixed with the transmitted light signal.

$$Up - Chirp : Δ {f}_{up} = {Δ}_{Doppler} - {Δ}_{transit} \qquad ( 3 )$$

$$Down - Chirp : Δ {f}_{down} = {Δ}_{Doppler} + {Δ}_{transit} \qquad ( 4 )$$

$$\frac{Δ {f}_{up} + Δ {f}_{down}}{2} = {Δ}_{Doppler} \qquad ( 5 )$$

$$\frac{Δ {f}_{up} - Δ {f}_{down}}{2} = {Δ}_{transit} \qquad ( 6 )$$

FIG. 2A illustrates a dead time at the beginning of each up or down-ramp while the light travels to the target and back. FIG. 2B illustrates an alternative linear FM ramp that does not incorporate a dead time between the up-ramp and the down-ramp, according to some embodiments. For the chirp profile shown in FIG. 2B, the frequency at the output of the optical mixer in FIG. 1 transitions linearly between Δfᵤ and Δf_{d} during the time period between the slope changes of the transmitted and received waveforms. The interferometer does not distinguish between negative and positive frequencies. In this case, only the absolute value of Δf is known as shown in FIG. 2B.

The scanner illustrated in FIG. 1 may operate as follows. The laser signal passes through a scanner that may vary the angle with which the light travels over the field of view. Successive laser signals may be scanned over the scene, covering the field of view. Some LiDARs may use a single laser with a 2-dimensional scanner, while others may use a vertical array of lasers which are scanned horizontally (or a horizontal array of lasers which are scanned vertically). Scanners may be mechanical with rotating mirrors, or they may use various methods to scan the lasers, including microelectromechanical systems (MEMS) mirrors, prisms, liquid crystal displays (LCDs), etc. Target objects in the field of view may affect the system as follows. The laser signals reflect from target objects, where the material, roughness and/or angle of the reflecting surface determines the reflectivity, or what fraction of the light is reflected. The LiDAR unit may receive a signal that is attenuated by the reflectivity, polarization change, and path loss from free space, specular components of the reflection, and/or diffuse components of the reflection. This path loss depends on distance as well as any impairments such as dust, fog, etc. The reflection, as received by the LiDAR will have a time delay. This delay is the time that light takes to make the round trip from the Lidar unit to the target and back. The time delay may manifest itself as a frequency shift of the RX frequency relative to the TX frequency. This shift is negative for up-ramps and positive for down-ramps. The reflection may also have a Doppler shift which is proportional to the velocity difference between the LiDAR unit and the target object. The Doppler shift is not dependent on the sweep direction. The LiDAR unit has information about the angles (ϕ, θ) with which the light was transmitted from the scanner settings. The LiDAR uses this angle information to reconstruct the scene in its field of view.

The synchronous receiver may operate as follows. The LiDAR receiver combines the reflected signal received and the transmitted signal, generating an interference signal via optical mixing. The result is a signal that may be used to determine the frequency difference between the transmitted and received light at a given instant in time. This low-frequency signal (typically in the MHz range) is processed using conventional RF signal processing techniques. The ability to process the received signal electronically, with a much lower bandwidth, may provide a large improvement in the achievable signal-to-noise ratio (SNR). This may allow distant objects to be imaged with much lower transmit laser power than what is used with a (time-of-flight) ToF LiDAR. The relative velocity of the target object may be measured directly through the Doppler shift.

Point Cloud. The scene may be rendered as an array of points, each with the attributes of: 1) The horizontal and vertical angles (ϕ, θ); 2). The reflectivity of the point illuminated by the LiDAR; 3) The distance between the illuminated point and the LiDAR; and 4) The relative velocity of the of the point illuminated by the LiDAR.

FMCW LiDARs in current development may typically render scenes as point clouds with 1000 to 100,000 points.

### Multiple Targets

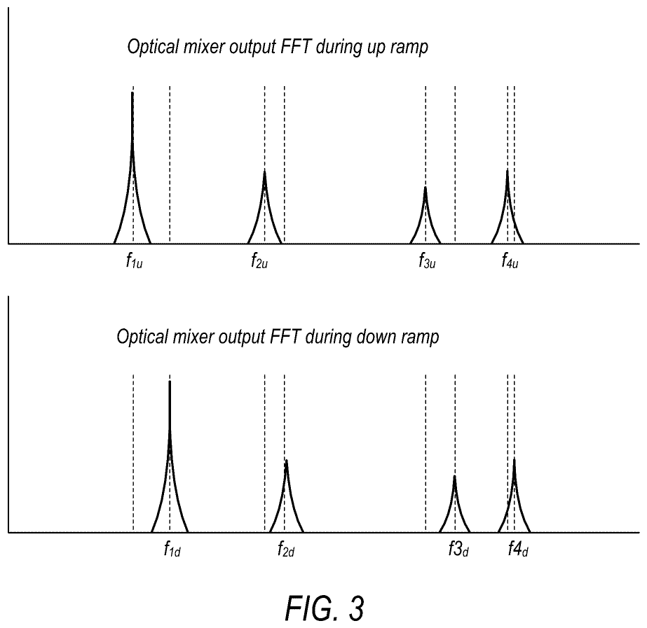

In some embodiments, LiDAR scene emulation is performed for a scenario with multiple reflections at a given angular location. For example, a particular direction (ϕ, θ) may experience several reflections from multiple reflectors at different distances, each with its own distance and velocity. FIG. 3 illustrates an example of a Fourier transform of a received waveform with multiple reflectors, taken during the time when the frequency ramps both up or down.

The frequency offset versus time can be computed from each return. These can be combined to give us a composite frequency deviation versus time.

$$ω ( t ) = \frac{\begin{matrix}{\sum }_{n = 1}^{N} {a}_{n} cos {ω}_{n} t {\sum }_{n = 1}^{N} {ω}_{n} {a}_{n} cos {ω}_{n} t + \\ {\sum }_{n = 1}^{N} {a}_{n} sin {ω}_{n} t {\sum }_{n = 1}^{N} {ω}_{n} {a}_{n} sin {ω}_{n} t\end{matrix}}{{( {\sum }_{n = 1}^{N} {a}_{n} cos {ω}_{n} t )}^{2} + {( {\sum }_{n = 1}^{N} {a}_{n} sin {ω}_{n} t )}^{2}} \qquad ( 7 )$$

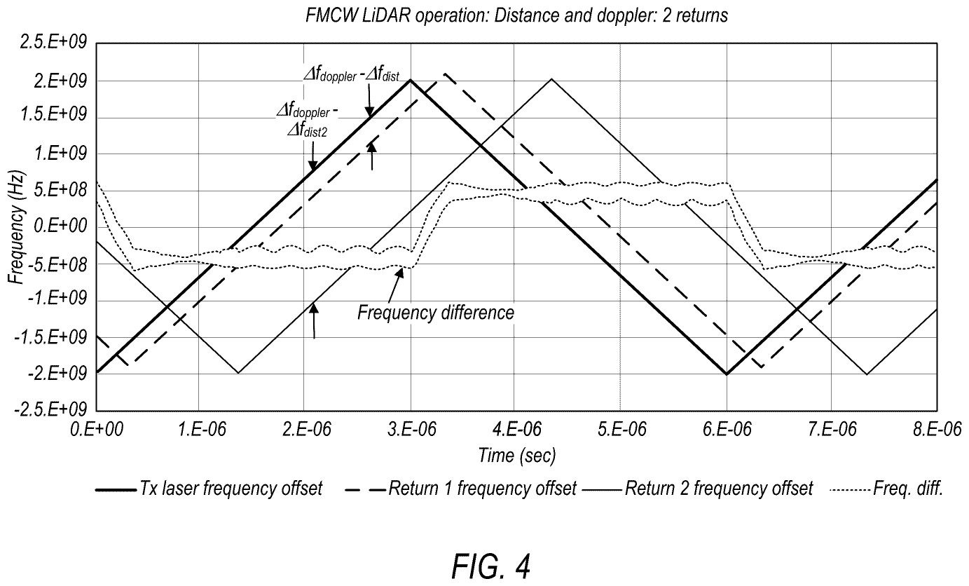

Consider a case where there are two targets. Each target has reflection amplitude and a frequency profile that is dependent on their respective distances. The resulting frequency profile can be computed and can be seen in Equation (8) and FIG. 4.

$$ω ( t ) = \frac{\begin{matrix}{\sum }_{n = 1}^{2} {a}_{n} cos {ω}_{n} t {\sum }_{n = 1}^{2} {ω}_{n} {a}_{n} cos {ω}_{n} t + \\ {\sum }_{n = 1}^{2} {a}_{n} sin {ω}_{n} t {\sum }_{n = 1}^{2} {ω}_{n} {a}_{n} sin {ω}_{n} t\end{matrix}}{{( {\sum }_{n = 1}^{2} {a}_{n} cos {ω}_{n} t )}^{2} + {( {\sum }_{n = 1}^{2} {a}_{n} sin {ω}_{n} t )}^{2}} \qquad ( 8 )$$

Some algebra simplifies Equation (8) to the following form:

$$ω ( t ) = ( \frac{{a}_{1}^{2} {ω}_{1} + {a}_{2}^{2} {ω}_{2}}{{a}_{1}^{2} + {a}_{2}^{2}} ) \frac{1 + \frac{{a}_{1} {a}_{2} ( {ω}_{1} + {ω}_{2} )}{{a}_{1}^{2} {ω}_{1} + {a}_{2}^{2} {ω}_{2}} cos ( {ω}_{1} - {ω}_{2} ) t}{1 + \frac{2 {a}_{1} {a}_{2}}{{a}_{1}^{2} + {a}_{2}^{2}} cos ( {ω}_{1} - {ω}_{2} ) t} \qquad ( 9 )$$

The result is illustrated in FIG. 4 for a second reflection with one tenth the amplitude of the first.

### Irregular and Oblique Targets

Irregular or oblique targets have reflections that may be emulated as multiple closely spaced targets. If the spacing of these multiple targets is smaller than the illuminated spot then the targets blend into each other. The tendency is for the frequency offset to be spread much like the case of two reflectors, extended for multiple reflectors.

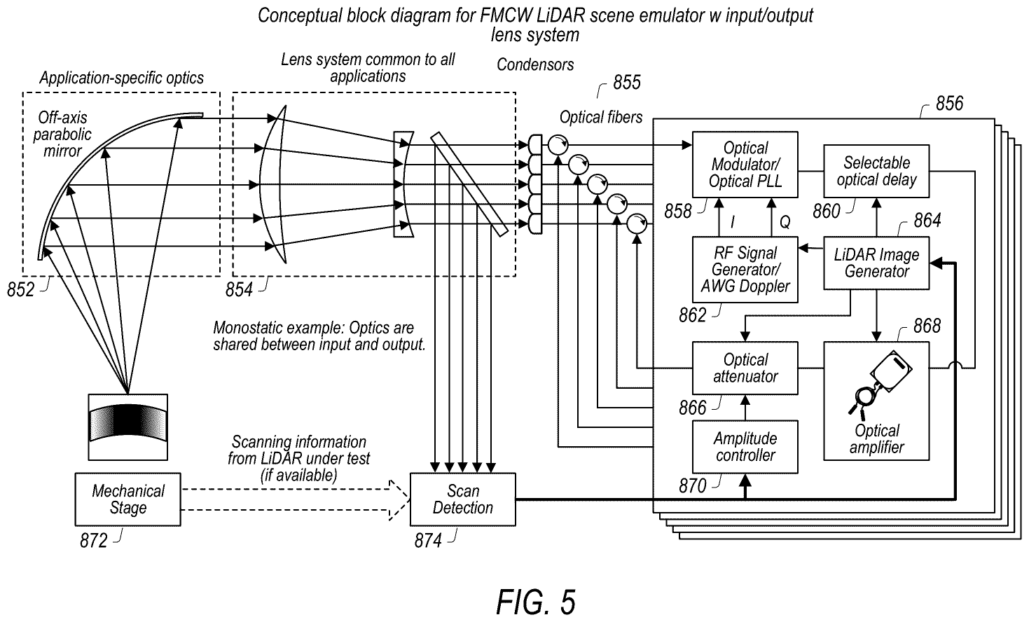

### FIG. 5: Emulator System for FMCW LiDARs.

FIG. 5 illustrates a LiDAR scene emulator for FMCW LiDAR units under test (UUTs) that utilizes several optical chains. As illustrated, a lens system 852, 854 is used to both receive the light from the LiDAR UUT and output the processed light back to the LiDAR UUT. As illustrated in FIG. 5, an application specific device such as the illustrated off-axis parabolic mirror 852 may be used to direct the light from the LiDAR UUT onto a lens system 854. The lens system 854 focuses different points of light received from the LiDAR UUT onto different optical fibers (or optical circulators) 855. A beam splitter is utilized to split the received light into Path 1 and Path 2. The light on Path 2 is fed to a scan detection system 874. Scanning information may (optionally) be received from the LiDAR UUT. The LiDAR image generator 864 receives light and/or scanning information to provide signals to an amplitude controller 870, an optical attenuator 866, an optical amplifier 868, and/or an RF signal generator 862 to determine the parameters of the optical modulator 858 and selectable optical delay 860 to modify the light on Path 1 to emulate the over-the-air environment. Subsequent to processing the received light by an optical modulator 858 and a selectable optical delay 860 in each of the optical fibers, the processed light is returned to the optical fibers for transmission back through the lens system and to the LiDAR UUT.

An optical in-phase/quadrature (IQ) modulator may be used to shift the frequency of an incoming signal. Optical IQ modulators have optical bandwidths in the range of 10's of GHz and optical local oscillator (LO) inputs in the optical wavelengths used by LiDARs. An RF signal generator can be used to generate a sine wave and a cosine wave at the same frequency. The cosine wave is fed to the I input and the sine wave to the Q input of the IQ modulator, such that I=cos (ωt) and Q=−sin (ωt). The optical signal at the output of the IQ modulator may be shifted by the angular frequency ω. The frequency ω may be chosen to correspond to the Doppler shift for the point being emulated.

To operate the system shown in FIG. 5, the LiDAR unit transmits a beam that has FMCW modulation. A scanning mechanism bends the beam through both vertical (θ) and horizontal (Φ) angles to cover the desired field of view (FoV). A system of lenses and mirrors captures the scanning beam and couples it into an optical fiber. Some of the light is picked off and sent to a scan detector to sense the beam position at any given moment. This information is fed to an image generator that creates the attributes to represent the emulated environment for each point in the scan. An optical IQ modulator is used to shift frequency and emulate the Doppler shift caused by moving objects. A selectable optical delay is used to emulate the distance to a reflecting object. A variable optical attenuator is used to emulate the level of light returning to the LiDAR unit. This emulates the intensity attenuation caused by distance as well as the effect of target reflectivity.

An optical circulator is used to return the modified light to the LiDAR unit under test through the same lens-mirror system. A system that passes the transmitted and received signals through the same path utilizes the reciprocity property of light. This is called monostatic operation. An alternative system can use a separate system of lenses to return the modified light. This is called bistatic operation.

The system shown in FIG. 5 is capable of emulating each of distance, Doppler shift, reflectivity and location for each point representing the emulated environment. However, it relies on expensive optical processing blocks (variable delay, variable attenuator, IQ modulator), and these expensive blocks are replicated for each laser in LiDARs that use multiple lasers. In addition, it cannot easily emulate multiple reflections or real scenes. Embodiments herein improve on this system by utilizing digital signal processing to emulate a FMCW LiDAR environment, as explained in greater detail below.

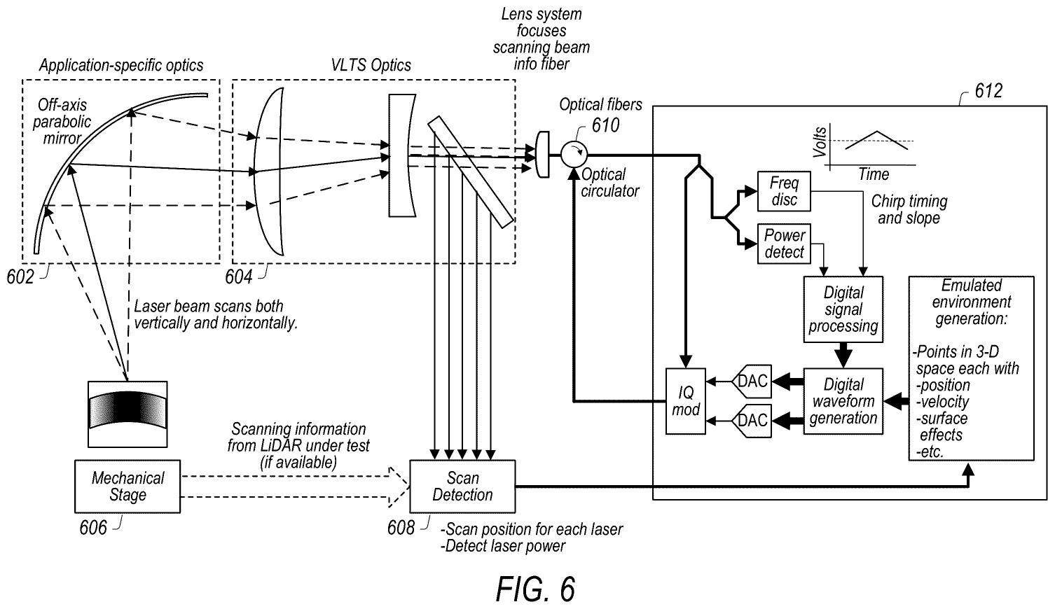

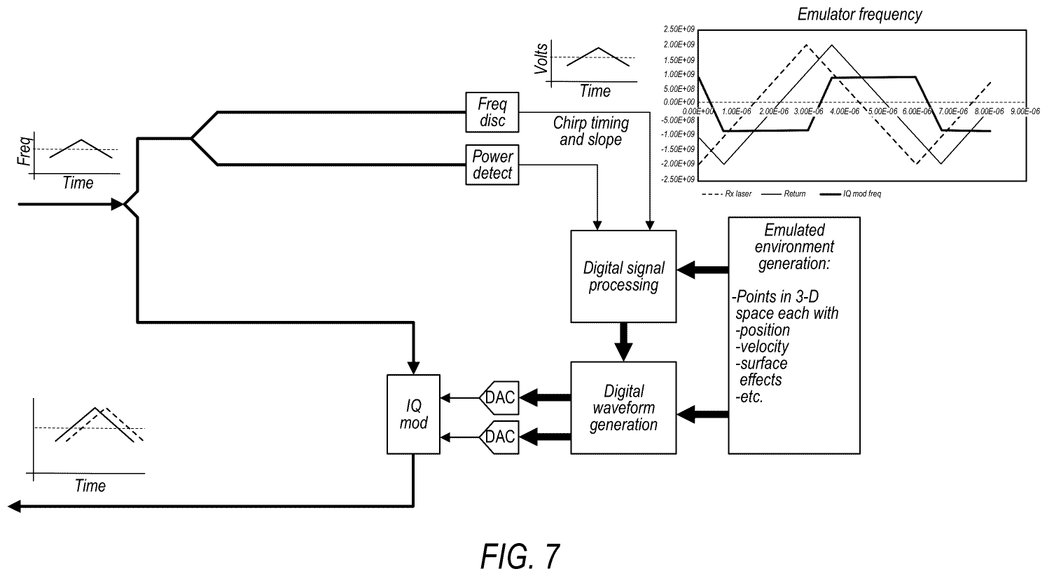

### FIGS. 6-7—System for FMCW LiDAR Environment Emulation Using Digital Signal Processing

Embodiments herein describe systems and methods for FMCW LiDAR environment emulation that are less expensive, more scalable to multiple lasers, capable of emulating multiple reflections, and able to use a LiDAR signature taken from a real environment. FIG. 6 illustrates an example FMCW LiDAR environment emulation system utilizing digital signal processing, according to some embodiments. The described system uses digital signal processing and an optical IQ modulator to emulate various parameters of each point in the emulated environment, including distance, velocity, intensity and multiple reflections. It can also emulate the effects of rough surfaces, obliquely angled surfaces and other effects that scatter or modify the reflected light. FIG. 7 illustrates the optical processing block in FIG. 6 in greater detail.

The system shown in FIG. 6 may operate by capturing light emitted by a LiDAR UUT into a fiber and placing the modified light into the fiber, similar as in the prior art system outlined in FIG. 5. Once the light is in the optical fiber it is split two ways, one path goes to the IQ modulator and will be the return signal to the LiDAR unit after modification by the emulator to mimic the effects of the emulated environment. The other path gets split again goes to two electro-optical processing blocks, a frequency discriminator to determine the slope and timing of the FMCW waveform, and a power detector to measure the intensity of the received light.

The signal from the frequency discriminator indicates the timing and slope of the FMCW waveform. The signal from the power detector measures received optical power. These are sent to a digital processing block and provide intensity and FMCW slope calibrations as well as timing information. Additional processing is done in the digital waveform generator. It converts the attributes of the particular point being scanned at a given instant into waveforms that, after digital-to-analog conversion, are fed to an optical IQ modulator.

The laser light passing through the IQ modulator is modified to mimic the effects of distance, reflectivity, Doppler, multiple reflections, and surface effects of either an actual target or a mathematically created one.

Some embodiments utilize an optical in-phase (I) and quadrature (Q) modulator to modify the phase, amplitude and frequency of the light in such a way that it emulates the effects of each point in the emulated environment on the reflected light.

The IQ representation of RF signals carrying information (data, music, etc.) is a signal processing tool in wireless communications, radar, and other RF and microwave applications. It is used here to impart information on an optical signal. Any form of modulation (AM, FM, PM, etc.) can be represented in terms of the sum of I and Q signals.

Modulation is a modification of a signal used to transmit information or a message superimposed on a carrier C(t)=A cos (ωt+Ø). There are three variables that can be used, either alone or in combination to carry information, the amplitude A, the frequency ω, and the phase Ø.

IQ modulation uses two carriers at the same frequency but offset in phase by 90 degrees (cosine and sine):

$$x ( t ) = I ( t ) cos ω t + Q ( t ) sin ω t \qquad ( 10 )$$

Amplitude modulation:

$$A ( t ) = \sqrt{{I}^{2} ( t ) + {Q}^{2} ( t )} \qquad ( 11 )$$

Phase modulation:

$$∅ ( t ) = {tan}^{- 1} \frac{Q ( t )}{I ( t )} \qquad ( 12 )$$

Frequency shift: A cos [(ω+ωₘ)t+Ø]=A cos ωₘt cos ωt−A sin ωₘt sin ωt (13)

For example, to incorporate an amplitude modulation by a factor of A and a frequency shift of ωₘ on an incoming signal with frequency ω, the following values for I(t) and Q(t) may be used by the IQ modulator:

$$I ( t ) = A cos {ω}_{m} t \\ Q ( t ) = - A sin {ω}_{m} t$$

Note that A may also be a function of time, A(t), to provide a time-dependent amplitude modulation. The information in a FMCW LiDAR is carried in terms of frequency shifts and amplitude changes over time. An IQ modulator can, with some signal processing and synchronization, be used to emulate the modifications to a light beam caused by the reflections from a target.

As a first example, consider a simple flat target at distance d and with velocity v. It is illuminated with a FMCW LiDAR beam that is continuously modulated with up and down-ramps illustrated as the Tx Laser Frequency Offset in FIG. 2B. The frequency of the return signal has a trajectory over time labelled Return Frequency Offset in FIG. 2B.

During the up-ramp, the frequency offset is equal to the offset due to Doppler minus the offset due to distance. During the down-ramp, the frequency offset is the sum of the Doppler and distance components.

$$Up - Chirp : Δ {f}_{u} = Δ {f}_{Doppler} - Δ {f}_{dist}$$

$$Down - Chirp : Δ {f}_{d} = Δ {f}_{Doppler} + Δ {f}_{dist}$$

The offset will transition between the Δfᵤ and Δf_{d} after the transition from positive to negative slopes in the transmitted signal and before the transition of the return signal (between peaks),

The difference in frequency can thus be computed as shown in FIG. 2B. This frequency vs time trajectory denoted in rad/sec as Δω(t) can then be converted to its equivalent IQ signals and fed to the IQ modulator as shown in FIG. 7.

$$I ( t ) = a cos Δ ω ( t ) , \qquad ( 14 )$$

$$Q ( t ) = a sin Δω ( t ) , \qquad ( 15 )$$

where a is the amplitude of the return signal and Δω=2πΔf.

In some embodiments, multiple reflective targets may be emulated. Consider the case of N targets, each with an amplitude of aₙ. An example with N=2 is shown in FIG. 3. The IQ components of the multiple reflections can simply be added:

$$I ( t ) = {\sum }_{n = 1}^{N} {a}_{n} cos Δ {ω}_{n} ( t ) , \qquad ( 16 )$$

$$Q ( t ) = {\sum }_{n = 1}^{N} {a}_{n} sin {Δω}_{n} ( t ) , \qquad ( 17 )$$

Any other modification of the light beam, including those caused by rough surfaces, steeply angled surfaces, irregular targets, beam propagation environment, and others can be converted to their equivalent IQ waveforms.

The ability to reproduce an arbitrary number of reflections using the IQ waveforms provides the opportunity of taking either the frequency offset waveforms or the equivalent IQ waveforms from an actual LiDAR scanning a real scene and reproducing them in the emulator. One can reproduce the effects of a specific environment on LiDAR beam propagation by directly taking the frequency offset signature or IQ signature for every point in the emulated environment. Applying these signature waveforms to the emulator as the LiDAR scans the environment reproduces the environment as a set of points, each with horizontal and vertical angle, intensity, velocity, and light scattering effect.

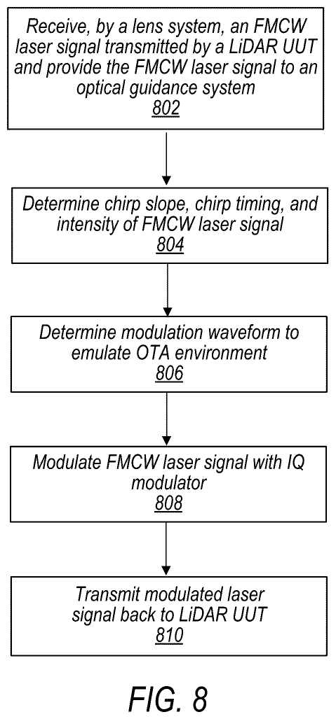

### FIG. 8—Flowchart for FMCW LiDAR Environment Emulation

FIG. 8 is a flowchart diagram illustrating a method for an emulator to emulate on over-the-air environment for testing a FMCW LiDAR UUT, according to various embodiments. The over-the-air environment may include one or more targets (which light will reflect off back to the LiDAR UUT) and/or a propagation environment (e.g., free space, fog, rain, etc.). The emulator system may include an optical system, an optical guidance system, and a digital-to-analog (DAC) converter. The optical guidance system may use any of a variety of methods of guiding light, for example optical fibers, optical waveguides in a photonic integrated circuit, dielectric light guides, or free space optical circuits where light travels in directed beams may be used, among other possibilities. The emulator system may further include a processor coupled to a non-transitory memory medium, where the processor is configured to determine a modulation waveform to emulate the over-the-air environment and direct operation of the emulator system. In some embodiments, the described methods and systems may be specifically tailored to operate with FMCW LiDAR UUTs.

Aspects of the method of FIG. 8 may be implemented by an emulator system, e.g., such as those illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 8 are described in a manner relating to the use of techniques and/or features associated with specific LiDAR methodologies, such description is not intended to be limiting to the disclosure, and aspects of the method of FIG. 8 may be used in any suitable LiDAR system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

At 802, an FMCW laser signal emitted by a LiDAR UUT is received by an optical guidance system. The optical guidance system may be composed of one or more optical fibers, optical waveguides in a photonic integrated circuit, dielectric light guides, or a free space optical circuit, among other possibilities. The FMCW laser signal may be emitted by the LiDAR UUT in a direction that corresponds to a particular point of a point cloud of the emulated OTA environment. In some embodiments, the laser signal may be captured by an optical lens system and provided by the lens system to the optical guidance system.

The laser signal may be emitted as a sweep of the LiDAR UUT over a field of view of the LiDAR UUT, and the method steps described in reference to FIG. 8 may be continuously iterated for successive laser signals of the sweep. The sweep of the laser signal may be modulated in frequency as a series of linear FMCW chirps such as those illustrated in FIGS. 2A-B. More generally, in the laser signal may be modulated as a non-linear series of chirps, as a series of chirps with varying slopes, or as pseudorandom frequency-modulation, among other possibilities. When the laser sweep undergoes a more complex frequency-modulation (e.g., a pseudorandom variation), parameters related to the modulation pattern may be provided to the emulator system, whereby the emulator system may predict aspects of the modulation pattern.

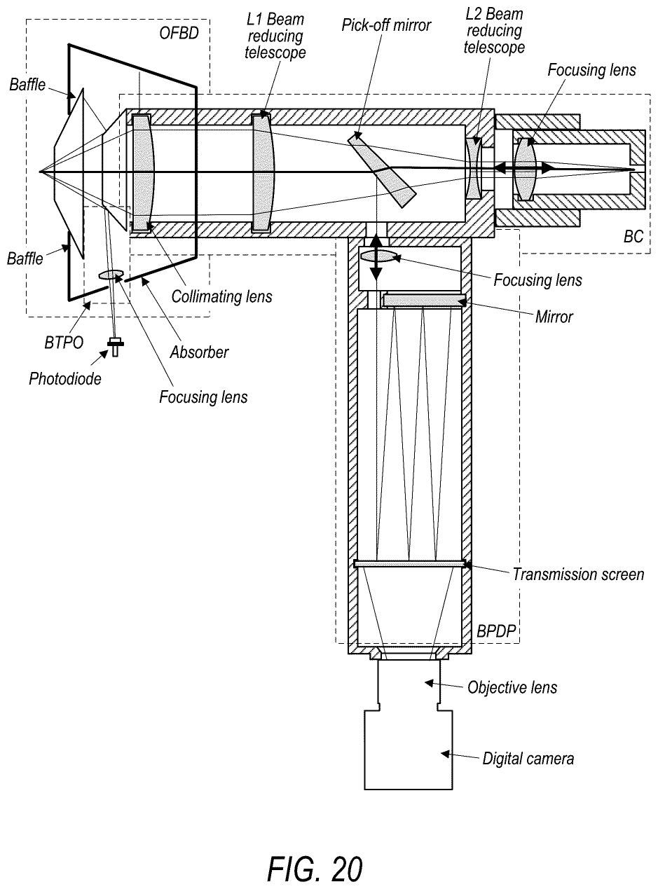

In some embodiments, prior to providing the FMCW laser signal to the optical guidance system, the emulator system may split the FMCW laser signal into a first signal and a second signal (e.g., with a beam splitter), where the first signal is provided as the FMCW laser signal to the optical guidance system and the second signal is provided to a beam characterization system to determine one or more of a divergence, a spot size, an elevation and an azimuth of the FMCW laser signal. An example system illustrating these embodiments is shown in FIG. 20, and is also shown as a scan detection device 874 in FIG. 5. The beam characterization system may measure the second signal split off from the original FMCW laser signal to determine the point in the field of view at which the FMCW laser signal is directed (e.g., the elevation and azimuth angles). The elevation and azimuth angles may in turn be utilized by a processor to determine how the FMCW laser signal is to be modulated to emulate the OTA environment. Additionally or alternatively, the beam characterization system may measure a spot diameter of the second signal to determine the divergence of the FMCW laser signal. The divergence may be used to determine whether the FMCW laser signal is in the far-field propagation region when it reaches the optical guidance system. If the FMCW laser signal is not in the far-field propagation region when it reaches the optical guidance system, transmissions parameters of the LiDAR UUT may be adjusted to correct this (e.g., by adjusting transmissions parameters such that the FMCW laser signal is in the far-field region when it is captured by the lens system and/or the optical guidance system).

In some embodiments, the optical guidance system includes a plurality of optical fibers configured to receive respective distinct subsets of a plurality of FMCW laser signals. For example, each distinct subset of FMCW laser signals may include laser signals from a distinct laser of multiple lasers of the LiDAR UUT, where each laser of the LiDAR UUT sweeps over a distinct portion of the field of view of the LiDAR UUT. In some embodiments, each laser of the plurality of lasers sweeps over a single line of the field of view of the LiDAR UUT, and the lens system is configured to focus light received along each line into respective points. For example, each laser may sweep horizontally in a line, and the lens system may focus each line into a point for reception by a respective optical fiber. Accordingly, each optical fiber may receive a disjoint set of laser signals from respective lasers of the LiDAR UUT.

At 804, the shape and intensity of the FMCW laser signal is determined. When the FMCW laser signal has a linear sawtooth profile (two examples sawtooth chirp profiles are shown in FIGS. 2A and 2B), the shape of the FMCW laser signal may include the slope and the chirp (i.e., the FM ramp) timing, in some embodiments. In some embodiments, the FMCW laser signal may have a non-linear frequency profile (e.g., a pseudorandom profile, or more generally any type of frequency profile). In these embodiments, the shape of the FMCW laser signal characterizes the frequency of the FMCW laser signal as a function of time. As used herein, “chirp timing” refers to the timing when the FMCW laser signals oscillates between increasing in frequency and decreasing in frequency. For example, for the example chirp profile shown in FIG. 2B, chirp timing refers to the timing of the peaks and troughs in the frequency profile of the FMCW laser pulse. In the example chirp profile shown in FIG. 2A, chirp timing refers to the timing of each change in slope, i.e., when the chirp profile changes from linearly increasing frequency to a flat (constant) frequency, from flat to a decreasing frequency, etc. As used herein, “chirp slope” refers to the slope of the change in frequency of the FMCW laser signal as a function of time, i.e., the slope of the linear plots shown in FIGS. 2A-B.

In some embodiments, to determine the slope, chirp timing and intensity of the FMCW laser signal, the optical guidance system splits the FMCW laser signal into a first signal, a second signal and a third signal, where the first signal is routed to the IQ modulator to be modulated to emulate the OTA environment at step 808, the second signal is routed to a frequency discriminator to determine the slope and the chirp timing of the FMCW laser signal, and the third signal is routed to a power detector to measure the intensity of the received light.

The power detector may include a photodiode that receives the third signal, where the amplitude of the received signal is proportional to the intensity of the received light. The measured intensity may be used to assist in determining the modulation waveform, as described in greater detail below in reference to step 806.

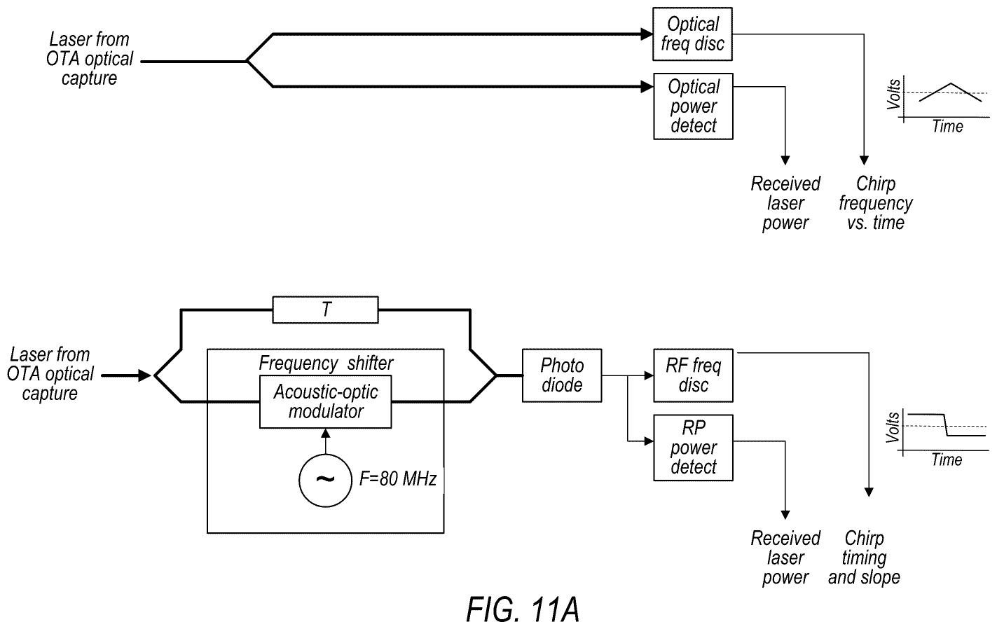

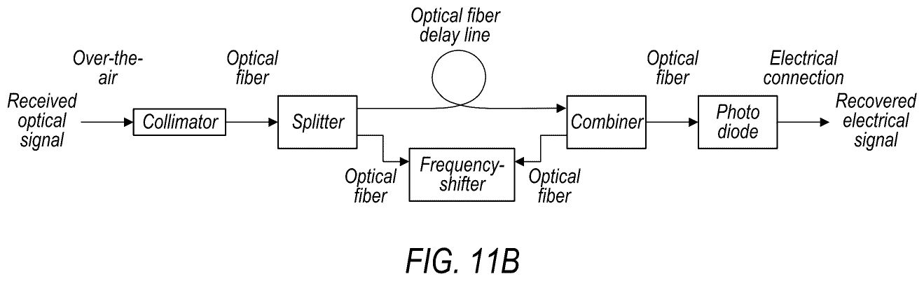

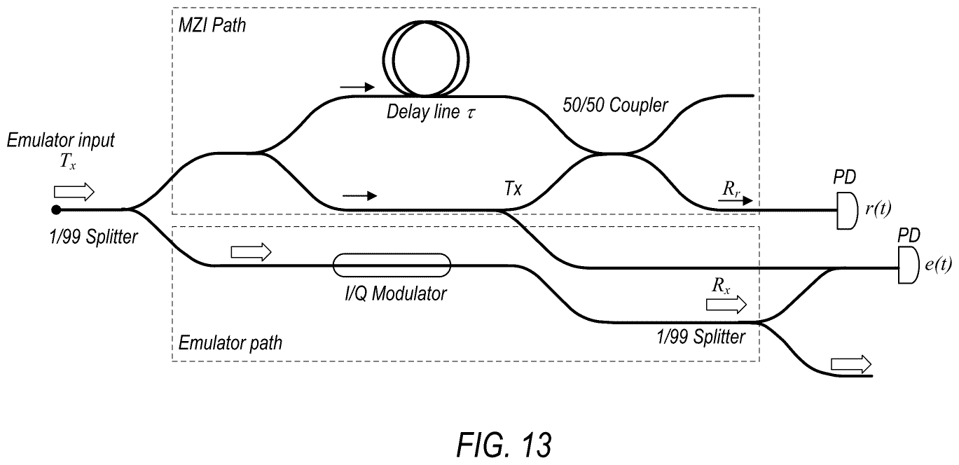

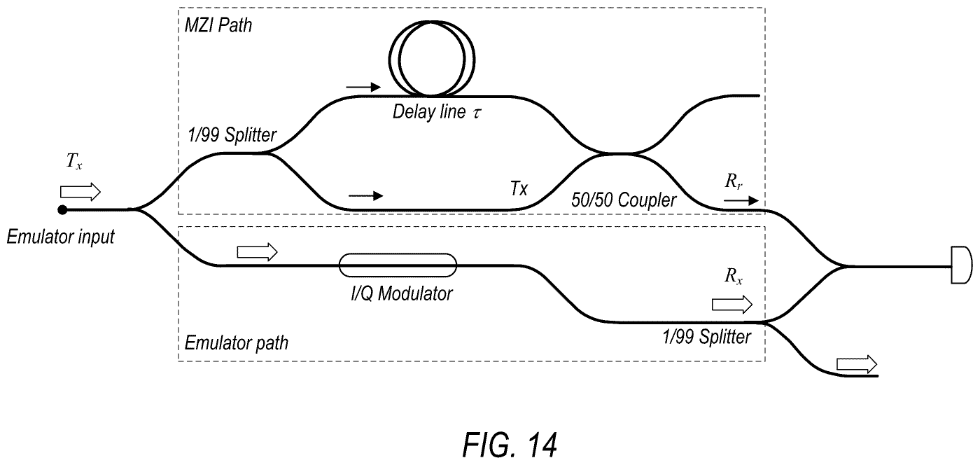

The slope and chirp timing of the FMCW laser signal may be determined by the frequency discriminator in various ways, according to different embodiments. Two methods utilizing either an interferometer with a frequency shift (“Method 1”) or a double optical interferometer (“Method 2”) are described in greater detail below. Systems configured to perform Method 1 are illustrated in FIGS. 11A-B, and systems for performing Method 2 are illustrated in FIGS. 13-14.

In some embodiments, the method for determining the slope and chirp timing with an interferometer with a frequency shift (Method 1) may proceed by splitting the second signal into a fourth signal and a fifth signal; routing the fourth signal through a delay line to delay the signal; and routing the fifth signal through an acousto-optic modulator to introduce a frequency shift. The fourth signal and the fifth signal are then recombined after routing them through the delay line and the acousto-optic modulator, respectively. The recombined fourth and fifth signal are received by a photodiode; and analyzed, by the frequency discriminator, to determine the slope and the chirp timing of the FMCW laser signal.

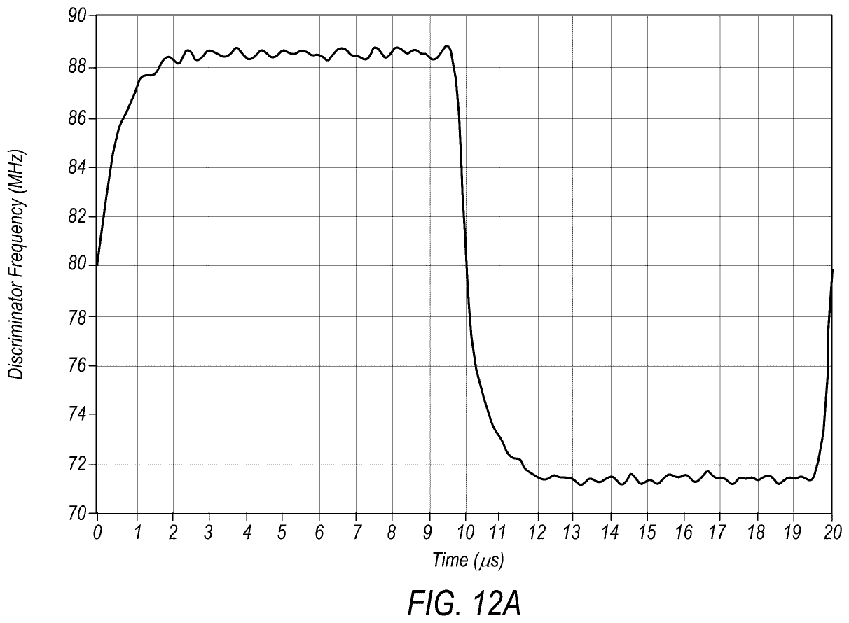

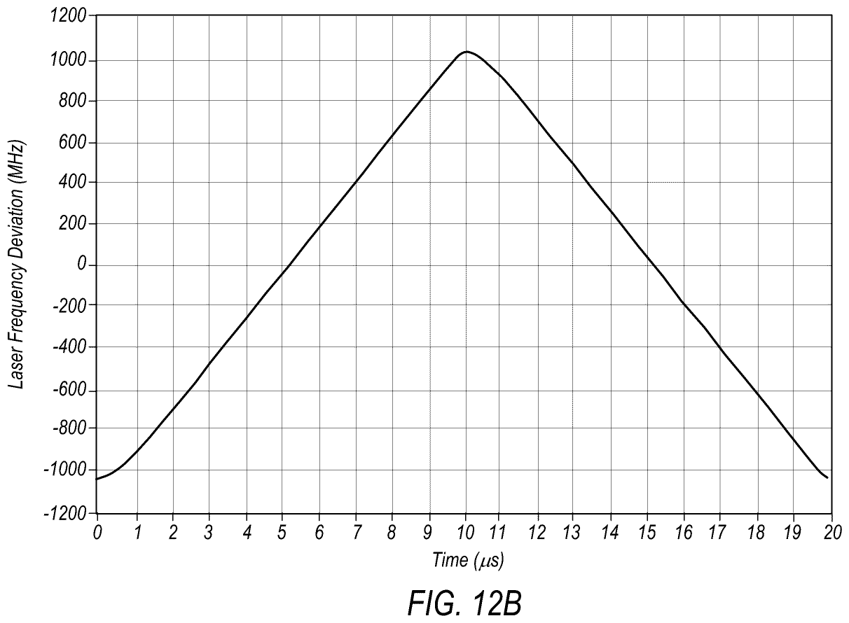

Without the acousto-optic modulator (i.e., if the time delayed signal were combined with an unmodulated signal), interference will result in a combined signal that will shift down in frequency during the up-ramp by an amount determined from the amount of delay (e.g., −8 MHz as one example), and will shift up in frequency by the same amount (e.g., +8 MHz) during the down-ramp. However, the frequency discriminator is unable to distinguish positive frequency shifts from negative frequency shifts, so in this case it would be unable to determine when the UUT was sweeping up vs. down in frequency. The acousto-optic modulator introduces a frequency shift to the fifth signal (80 MHz in the example illustrated in FIG. 11), such that the combined signal will be shifted in frequency by the combination or difference between these two frequency shifts (e.g., 80 MHz-8 MHz=72 MHz during the up-ramp and 80 MHz+8 MHz=88 MHz during the down-ramp). Accordingly, the frequency discriminator will be able to identify the up and down slopes of the laser sweep. The midpoint of the crossing from the 72 MHz shift to the 88 MHz shift may be identified as the peaks and troughs of the oscillating sweep pattern, to determine the timing of the FMCW laser signal. As described in greater detail below in reference to FIGS. 12A-12B, the discriminator frequency may be integrated over time to determine the slope of the FMCW laser pulse.

In some embodiments, determining the slope and the chirp timing of the FMCW laser signal may utilize a double optical interferometer (Method 2). Method 2 has some advantages over Method 1, as it does not utilize an expensive acoustic-optic modulator. However, it involves a calibration step where the system “guesses” whether the LiDAR UUT is currently in an up-ramp or a down-ramp and then determines whether the guess was correct, as described below. The method may proceed by splitting the second signal into fourth, fifth, sixth and seventh signals; routing the fourth signal through a delay line to apply a delay; combining and measuring the fourth and fifth signals after routing the fourth signal through the delay line to obtain a reference signal r(t); routing the seventh signal through an in-phase/quadrature (IQ) modulator, where the IQ modulator emulates the delay applied by the delay line; and combining and measuring the sixth and seventh signals after applying the IQ modulator.

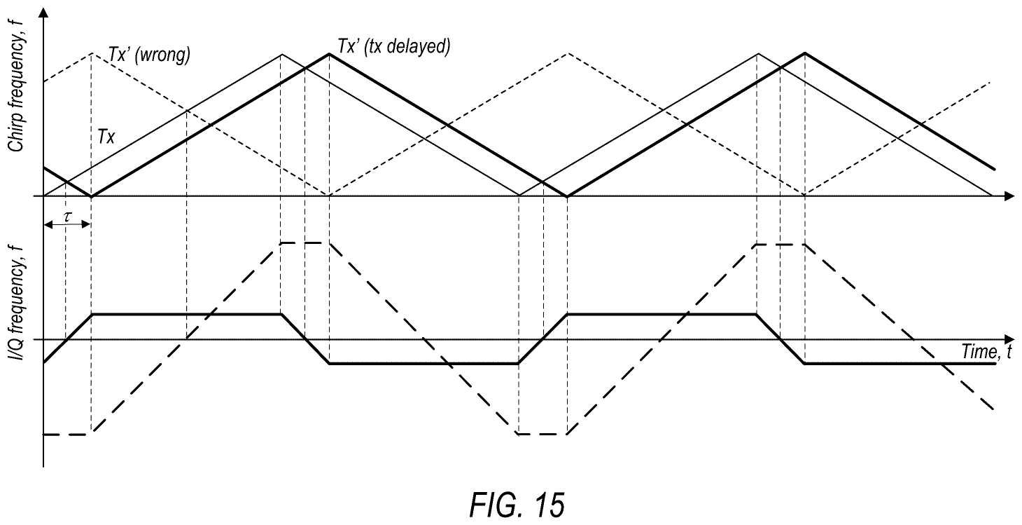

In method two, the fourth signal (routed through the delay line) and the fifth signal (unmodulated) are combined, which will give successive positive and negative shifts in frequency at the output reference signal r(t), which the frequency discriminator is unable to distinguish between (as described above in reference to Method 1). The seventh signal will go through an IQ modulator to frequency shift the seventh signal by the same amount as the delay line. The system will arbitrarily guess whether the sweep is currently on an up-ramp or a down-ramp, and shift the seventh signal accordingly. The seventh signal is then combined with the (unmodulated) sixth signal (which is substantially similar to the fifth signal), leading to a time varying output emulator signal e(t). The two outputs r(t) and e(t) may then be processed, as described in reference to FIG. 15, to determine whether the guess was correct. Accordingly, a first calibration FMCW laser signal may be received with a guess, as described, after which the FMCW emulator will be able to distinguish up-ramps from down-ramps, and the chirp timing and chirp slope of the FMCW laser signal may be determined as described above.

At 806, a waveform (also called a “modulation waveform”) is determined based at least in part on the chirp slope, chirp timing and intensity of the FMCW laser signal to emulate effects on the FMCW laser signal of an over-the-air (OTA) environment. The OTA environment may include both a propagation environment that incorporates distance attenuation as well as dispersive effects of the air in the emulated environment (e.g., fog, rain or other dispersive environments) as well as one or more targets of arbitrary shape, size, velocity relative to the LiDAR UUT, surface roughness/regularity, and reflectivity.

In some embodiments, the modulation waveform may include an I(t) function and a Q(t) function as shown in Equation 10 above, from which may be determined the amplitude modulation, phase modulation, and frequency shift, as shown in Equations 11-13. The modulation waveform may then be provided to the IQ modulator to modulate the FMCW laser signal and emulate the OTA environment. The amplitude of these functions may be determined based on the distance and reflectivity of the emulated point in the point cloud, while the frequency of the I and Q functions may be determined based on the distance and velocity of the emulated point in the point cloud.

The chirp slope and chirp timing may be used to determine aspects of the modulation waveform to emulate velocity of a target in the OTA environment, in some embodiments. For example, a relative velocity between the LiDAR UUT and a target will introduce a Doppler shift Δf_{Doppler} that is subtracted from the frequency shift from the delayed reception of the reflected light Δf_{dist} during the up-ramp, and is added to the frequency shift from the delayed reception of the reflected light Δf_{dist} during the down-ramp (as described in greater detail above in reference to Equations 3-6). Accordingly, the chirp timing may be used to determine when the Doppler shift resultant from the velocity of the target should add to or subtract from the frequency shift of the IQ modulated FMCW return laser signal. The chirp slope may be used to determine the magnitude of Δf_{dist} for a given distance of the reflected target. For example, a given distance corresponds to a particular time delay (e.g., 9 nanoseconds), and the frequency shift Δf_{dist} will be proportional to the produce of the time delay and the chirp slope.

In some embodiments, the modulation waveform provided to the IQ modulator is determined further based at least in part on the measured intensity of the FMCW laser pulse. For example, in some embodiments the lens system may receive light from the LiDAR UUT at different intensities depending on the position of the FMCW laser signal within the sweep. For example, as the LiDAR UUT sweeps across a line, the path distance of the laser signal from the UUT to the optical fiber may vary, such that the intensity of the light also varies during the sweep (e.g., even when the UUT is emitting a constant intensity signal) as a function of time, B(t). The power detector may measure the intensity B(t), which may be used to determine an amplitude modulation A_{c}(t) (e.g., using Eq. (11)) to compensate for this variation in intensity, where the subscript “c” indicates a compensatory amplitude. Said another way, the amplitude modulation A_{c}(t) may be determined such that the product A_{c}(t)·B(t) is a constant in time (or approximately constant). Note that the entire amplitude A(t) that is applied to the FMCW laser signal by the IQ modulator may include both A_{c}(t) (to compensate for variation of the received laser signal intensity) as well as a second time-varying emulation component Aₑ(t) that emulates the varying distance and reflectivity of targets in the emulated OTA environment, i.e., A(t)=A_{c}(t)·Aₑ(t).

The contribution Aₑ(t) may be determined based on properties of the particular point of the point cloud of the emulated OTA environment toward which the FMCW laser pulse is directed, such as the distance to and reflectivity of a target at that point. For example, Aₑ(t) may decrease with increasing distance and decreasing reflectivity of a target in the OTA environment.

In some embodiments, determining the modulation waveform is performed in advance based on information related to the chirp pattern of the FMCW laser signal. For example, advance knowledge of the timing of the chirp pattern may enable the processor to determine the modulation waveform prior to receiving the FMCW laser signal. Advantageously, this may prevent or reduce latency in providing the modulated laser signal back to the LiDAR UUT.

In some embodiments, the modulation waveform may be generated by a digital waveform generator as a digital waveform and provided to a digital-to-analog converter (DAC). The DAC may convert the digital waveform to an analog waveform, and provide the analog waveform to the in-phase/quadrature (IQ) modulator to modulate the first signal split off from the FMCW laser signal, which will then be returned to the LiDAR UUT at step 810.

In some embodiments, determining the modulation waveform to emulate the over-the-air environment is performed by receiving LiDAR scanning data from a physical OTA environment and determining frequency offset waveforms or equivalent IQ waveforms from the LiDAR scanning data.

In some embodiments, the over-the-air environment includes multiple targets. For example, the OTA environment may include multiple reflective objects as targets at distinct distances and/or having distinct velocities. In these embodiments, the modulation waveform may be determined to emulate respective reflections from each of the multiple targets. Emulating the respective reflections from each of the multiple targets may include performing a summation over the IQ components of each of the respective reflections, as described above in reference to Equations 7-9.

In some embodiments, the OTA environment includes a target that is a rough surface, an irregular target, and/or an oblique surface. In these embodiments, emulating the over-the-air environment may include emulating the rough surface, the irregular target, and/or the oblique surface by determining a modulation waveform that spreads a spectral distribution of the FMCW laser signal. Spreading the spectral distribution of the FMCW laser signal may be performed by including a plurality of reflections at slightly different distances, which will correspondingly have slightly different frequency shifts in their respective IQ values. The combination of the plurality of IQ values, when used to modulate the FMCW laser signal, will then emulate non-specular reflection by spreading the spectral distribution of the laser signal.

At 808, the FMCW laser signal is modulated based on the modulation waveform. The IQ modulator may combine the modulation waveform with the FMCW laser signal to emulate effects on the FMCW laser signal of propagation through the OTA environment. For example, when the incoming FMCW laser signal has the form B(t) cos ωt and the IQ components have the form I(t)=A(t) cos ωₘt, and Q(t)=−A(t) sin ωₘt, the modulated laser signal will be equal to A(t) B(t) cos ωt cos ωₘt−A(t) B(t) sin wt sin ωₘt=A(t) B(t) cos [(w+ωₘ) t], introducing a frequency shift of ωₘ and modulating the amplitude by a factor of A(t).

Modulating the FMCW laser signal with the modulation waveform may perform IQ frequency-modulation to frequency-shift, time-shift, and/or modify the intensity of the FMCW laser signal. Implementing IQ frequency translation may be used to emulate Doppler shift and/or time delays for the FMCW LiDAR UUT. Additionally or alternatively, modulating the FMCW laser signal may implement optical amplitude modulation by selectively attenuating and/or amplifying the FMCW laser signal to emulate reflectivity and path loss at the target being emulated in the over-the-air environment. The optical amplitude modulators may include separate optical attenuator and amplifier devices, or they may be combined into a single attenuator/amplifier device for each optical chain. Modulating the FMCW laser signal may be performed optically to maintain coherence between the received laser signal and the modulated laser signal that is transmitted back to the LiDAR UUT.

At 810, the modulated laser signal is transmitted to the LiDAR UUT. The modulated laser signals may be transmitted to the LiDAR UUT through the same lens system used to receive the laser signals from the LiDAR UUT, or they may be transmitted through a separate dedicated output lens system. For example, each of the optical fibers may be configured to transmit the modulated laser light back through the lens system, for reception by the LiDAR UUT. The LiDAR UUT may then reproduce a LiDAR image based on the received modulated laser light.

The method steps 802-810 may be repeated for a continuous stream of FMCW laser signals, for example, as the LiDAR UUT sweeps through a series of points to map out a field-of-view of the OTA environment. As one example, the LiDAR UUT may perform a raster scan to transmit laser signals that cover the solid angle of the field of view of the LiDAR UUT with a preconfigured resolution of points. Prior to performing the method steps of FIG. 8, the emulator system may receive information describing the scan pattern for the sequence of laser signals and may utilize this information to generate waveforms that emulate the effect of the corresponding points in the point cloud of the OTA environment. Alternatively, the emulator system may be configured to detect the direction of the FMCW laser signals in real time to identify the appropriate points in the point cloud for generating the waveform to emulate the OTA environment.

### Additional Technical Description

The following paragraphs describe additional aspects of the described embodiments:

### Emulation and Testing of LiDAR Targets and Environments

A LiDAR is an imaging device designed to represent the target environment as a collection of points referred to as a point cloud. An example of a point cloud is shown in FIG. 1 at the lower right corner. To emulate a target environment, a virtual environment is created that can mimic the real world as closely as possible for all properties impacting LiDAR functionality. Such a virtual environment may be called an Emulated Environment, given that its purpose is to help test a LiDAR unit in an emulated world. An effective emulator reproduces the same or at least a similar point cloud in the LiDAR as a real-world environment would have done.

Unlike a photograph that captures a 2-dimensional representation of a 3-dimensional scene, a point cloud can provide more than just spatial information for each point in the 3-dimensional scene. For example, the emulated environment physically mimics the reflection of the emitted laser light (usually IR) from the real-world surfaces in the field of view, providing additional information besides the location of the reflected point.

For example, the reflectance of objects in the real world depends on wavelength and is determined by the structural and optical properties of the surface, such as shadow-casting, multiple scattering, mutual shadowing, transmission, reflection, absorption, emission by surface elements, facet orientation distribution, and facet density. A Bidirectional Reflectance Distribution Function (BRDF) may be utilized to characterize these properties. The BRDF can be mathematically described, and the mathematical description may be used in the emulation, in some embodiments.

When infrared light from a LiDAR strikes an object in its path, it can be reflected, absorbed, and/or transmitted. The reflection of IR from an object at a given point of incidence can be described as a function of illumination geometry and viewing geometry. Absorption of IR by a target object is dependent on the type of surface, type of material, color of the surface, IR wavelength, etc. Transmission of IR through an object is dependent on object thickness, transparency, IR wavelength, etc.

For emulating an environment, each point in a point cloud may have additional information, such as light sources in the environment, physical attributes such as material type, type of surface, reflectivity, transparency, density, etc. Beam propagation environment effects such as rain or fog may also be emulated.

The color of an object may have a significant impact on the intensity of the reflection as well as emission properties, both of which impact the BRDF. Several studies indicate that white surfaces tend to reflect IR more while dark/black surfaces reflect less. This behavior is generally observed although there is no direct correlation between reflected visible light vs reflected IR light. For each material, the color, type of surface, wavelength, angle of incidence and other physical properties impact the IR spectral response and BRDF information at each point. The information may or may not be a part of the point cloud but is utilized in a correlated form for calculating intensity of the reflected IR from the LiDAR source.

### Beam Propagation Environment

The laser beam typically travels through the air, but depending on the environmental situation (e.g. rain, fog, dust, smoke, etc.), the laser beam may be impaired. The primary impairment is typically reduction in intensity, aka attenuation. Other impairments may cause the laser beam to be scattered, diffused, or simply get fully absorbed. The reduction in intensity is related to the density of the rain, fog, dust, smoke etc. present in the path of the beam.

### Captured Data/Point Cloud

The data captured by a LiDAR will be referenced to the LiDAR sensor placed at the origin of a coordinate system. The point cloud data may represent point data in cartesian coordinates (x, y, z) or spherical coordinates (r, 0, ω). A captured point may contain the following information in addition to the coordinate location: a) Intensity at a given point in the 3D scene, and b) Relative velocity at the given point with respect to the LiDAR.

Additionally, there are cases where targets don't reflect or absorb all the light hitting a particular point. Some of the light may be transmitted further (a transparent windshield for example) and can result in additional reflections along the same 0 and ω angles, but with longer delays and different velocities. Many LiDARs can process several reflections, aiding in identification and classification the objects being imaged.

Some LiDARs may include object identification and classification in addition to creating a 3-D image.

### LiDAR Output Validation

The accuracy of the LiDAR point cloud can be assessed by comparing the point cloud data generated by the LiDAR with points in the emulated environment. The data to be compared can include position (r, θ, ω), velocity, reflectivity, etc. The validation may determine whether the output data meet the prescribed spatial tolerance. It is also expected for the statistical distribution of the measured data point cloud data to be within a requested range. The spatial tolerance limits and statistical distribution are determined by the volumetric resolution of the LiDAR at a given point in space, primarily determined by the distance of the point from the LiDAR.

### Synchronization

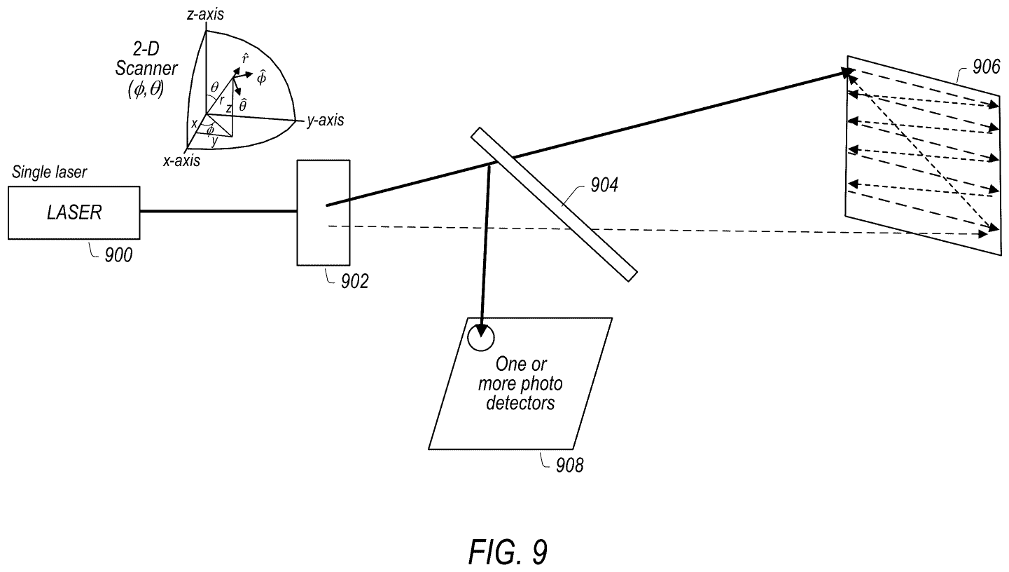

Knowledge of the LiDAR sensor's beam scanning position is important for representing an environment as a set of points. In some embodiments, the emulator knows the position of the scanning laser beam in advance of generating the IQ (or frequency offset) profile for that particular scan point. Knowing the position in advance may allow time for memory retrieval of the parameters as well as completion of any involved computations. Synchronization for scanning patterns that are repetitive may be done with a sync signal at a reference point in the cycle. This sync signal can be provided by the LiDAR unit under test or it may be generated by having a-priori knowledge of the scanning waveform shape and a scan detector that detects the laser beam at a particular point. An unknown repetitive scan pattern may be measured using an optical measurement system including a camera. In some embodiments, detecting the laser beam may be performed using a beam splitter and one-or more photodetectors that produce a signal when the laser projects a particular location on a detector array, as shown in FIG. 9.

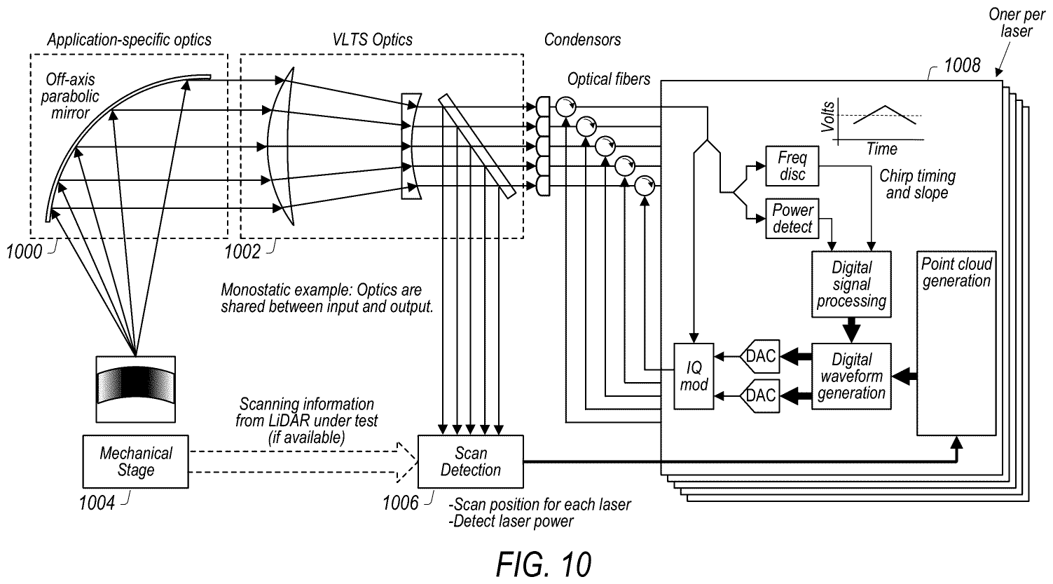

In various embodiments, LiDAR targets may be emulated with either a single beam or multiple beams. For example, some LiDAR designs use a single beam of light that is scanned in two dimensions over the entire field of view. Other designs use multiple laser beams, each scanning a portion of the target area. The system shown in FIG. 6 may be used to emulate targets for single beam LiDARs. Target emulation for multi beam LiDARs may be achieved by replication of the optical processing block for each laser in the LiDAR as shown in FIG. 10.

The optical system to capture the laser light (lenses, mirrors, condensers, etc.) may be designed specifically for the number of lasers of the LiDAR UUT. The system may utilize an optical processing block for each laser in the LiDAR.

### Frequency Discrimination and Power Detection

Embodiments herein for emulating LIDAR targets as described in FIGS. 6 and 10 utilize methods for detecting the timing, frequency slope and direction (up/down) of the frequency chirp and measuring the power of the received laser signal. Two methods may be utilized to accomplish this, in various embodiments.

Method 1: Using an Interferometer with Frequency Shift to Measure Power and Chirp.

The system of FIG. 6 utilizes measurement and timing of the frequency-vs-time curve of an optical FMCW source, both for determining its key characteristics and for determining the timing of critical events in the waveform. One method to measure the frequency over time uses a delay-line discriminator, as shown in FIG. 11A. A delay-line interferometer may be used to detect the FMCW chirp. Much like the FMCW LiDAR operation described in FIG. 2B, the beat frequency at the output of the of the photodiode (optical mixer) is proportional to the delay and to absolute value of the slope of the FMCW ramp (also called a chirp).

The interferometer formed by feeding two optical signals with different frequencies cannot differentiate between negative and positive frequency deviations. A system that shifts the optical frequency can be used to bias the interferometer output so that the sign of the frequency deviation is known.

In the example shown in FIG. 11A, an acousto-optical modulator and an RF oscillator are used to shift the laser light by 80 MHz. The delay is chosen to produce an output difference of negative 8 MHz during an up slope and a positive 8 MHz during a down slope. Shifting the lower branch of the interferometer by 80 MHz produces 72 MHz during the up-slope and 88 MHz during the down-slope.

The output of the photodiode has an amplitude that is proportional to the laser power applied to it. Detecting the level of the RF signal at the photodiode output provides an indication of the intensity of the laser light input. The optical signal is directed into a collimator, which concentrates the signal power into an optical fiber. At this point, the signal can be represented in general as:

$$A ( t ) = A cos [ 2 π {\int }_{{t}_{0}}^{t} f ( u ) du ] , \qquad ( 18 )$$

where A is the amplitude of the signal, f(t) is the time-varying optical frequency in Hz, and to is an arbitrary time to start the integration. Without loss of generality, this equation can represent either the electric field intensity or the magnetic field intensity. Note that the instantaneous phase (in radians) is the quantity inside the brackets and that the instantaneous frequency f(t) (in Hz) is the time derivative of the definite integral.

Once in the fiber, the signal may be split equally into two fiber paths. One path includes a delay line consisting of a known length of fiber. Its effect on the signal is to introduce a delay time τ, and possibly some attenuation, which will be accounted for as a new amplitude B. The output of this path is:

$$B ( t ) = B cos [ 2 π {\int }_{{t}_{0}}^{t - τ} f ( u ) du ] . \qquad ( 19 )$$

The other path includes a frequency-shifter, which adds a fixed offset to the frequency of the signal in the fiber. An acousto-optic modulator (AOM) is a convenient choice for the frequency-shifter, although there are other technologies available. As a practical matter, the frequency-shifter also adds some delay, but for the purpose of analysis we can ignore the delay (or at least account for it later as a net difference in delay between the two arms). The output of the frequency shifter is

$$C ( t ) = C cos [ 2 π {\int }_{{t}_{0}}^{t} ( f ( u ) + {f}_{s} ) du ] , \qquad ( 20 )$$

where fₛ is the constant frequency offset and C is the amplitude of the output signal.

The outputs of the two paths are added together in a combiner. The output of the combiner is a signal representing the mathematical sum of the two combiner inputs. This output is fed into a photodiode, which converts incident optical power to an electrical signal. Since the photodiode measures optical power as an electrical amplitude, the input optical signal is inherently squared in the process, causing a multiplication-based mixing of the two signals from the combiner. Mathematically, the electrical output of the photodiode is, except for a scale factor:

$$E ( t ) = {( B cos [ 2 π {\int }_{{t}_{0}}^{t - τ} f ( u ) du ] + C cos [ 2 π {\int }_{{t}_{0}}^{t} ( f ( u ) + {f}_{s} ) du ] )}^{2} . \qquad ( 21 )$$

The photodiode will not produce electrical output at optical frequencies or beyond, so many of the terms of this equation, once expanded, can be ignored. Also, DC content can be ignored, since only the recovered beat frequency is of interest. After expanding the equation and eliminating the unwanted products, it simplifies to

$$E ( t ) = BC cos ( 2 π {\int }_{{t}_{0}}^{t} ( f ( u ) + {f}_{s} ) du - 2 π {\int }_{{t}_{0}}^{t - τ} f ( u ) du ) . \qquad ( 22 )$$

The result is a cosine whose amplitude is the product of the amplitudes of the two arms and whose frequency is the difference between the frequencies in the two arms. This can be rearranged to read:

$$E ( t ) = BC cos ( 2 π [ {\int }_{t - τ}^{t} f ( u ) du + {f}_{s} t - {f}_{s} {t}_{0} ] ) . \qquad ( 23 )$$

Note that evaluating the definite integral here and taking the derivative with respect to t of the expression inside the brackets yields an instantaneous frequency of f(t)−f(t−τ)+fₛ. Since f(t) is expected to vary within a limited range, the difference frequency f(t)−f(t−τ) will take both positive and negative values over time. Without the added bias term in the equation, it may not be possible to determine the sign of the frequency deviation from the cosine signal, as cos (x) is a symmetric function. The inclusion of fₛ resolves the uncertainty by keeping the difference frequency positive at all times. This makes it possible to recover the difference frequency and ultimately the frequency variation of the source unambiguously, as long as fₛ is at least as large as the peak magnitude of f(t)−f(t−τ), which is approximately the frequency vs. time slope of the source multiplied by the delay time difference (see derivation below).

The plot in FIG. 12A illustrates the demodulated frequency vs time from a discriminator with a 38.52 ns time difference between the two paths, where fₛ=80 MHz and the source is a 1550 nm laser with a triangle-wave modulated frequency. The output is the derivative of the frequency vs time curve. (Note that the time derivative of a triangle wave is a square wave).

The timing of the end points of the triangle wave is easily recovered from the 80 MHz crossings of this waveform, and the frequency vs. time slope of the triangle wave is characterized by the flat sections. This is illustrated in the plot shown in FIG. 12B.

As mentioned above, the discriminator frequency is approximately proportional to the slope of the original frequency-modulation, and so the original frequency-modulation of the source could be approximated by integrating the discriminator frequency vs. time curve. However, in order to recover the triangle waveform more precisely, the operation of the discriminator has to be reversed precisely. If f(t) has the Laplace transform F(s), then f(t−τ) has the Laplace transform e^{-τs} F(s). Then the discriminator's response of f(t)−f(t−τ) has a frequency response of:

$$( 1 - {e}^{- τ s} ) F ( s ) . \qquad ( 24 )$$

As a side note, observe that as τ→0, the expression above becomes approximately:

$${e}^{- τ s / 2} τ sF ( s ) , \qquad ( 25 )$$

which is the Laplace transform of the time derivative of f(t) delayed by time τ/2 and multiplied by τ. Accordingly, the discriminator approximates the time derivative of the source frequency-modulation, at least for sufficiently small delay τ and analysis frequency s.

The more precise transfer function (1−e^{-τs}) is easily reversed using digital signal processing techniques. FIG. 12B shows the recovered frequency-modulation from the measured output frequency of the discriminator shown in FIG. 12A, using digital filtering.

Note that a relative source power indication can be recovered from the photodiode output from the amplitude BC of the beat product. This relative power measurement could be calibrated by presenting a source with a known amount of power to the discriminator system. Furthermore, BC could be monitored over time to measure the amplitude variation of the source.

### Method 2: Using a Double Optical Interferometer.

A second method for extracting the FMCW slope and chirp timing utilizes a double optical interferometer, in some embodiments. A FMCW LiDAR UUT uses an interferometer to detect the time delay of a LiDAR signal as it travels from the UUT and is reflected back by an object in its path. Operation of an interferometer can measure a frequency difference, but not the sign of that difference. The interferometer cannot tell a negative frequency deviation from a positive one. Knowing the sign of the FMCW slope is critical to the operation of the IQ-based LiDAR target emulator.

The principle of the FMCW slope sign is based on the comparison of the expected response signal (reference signal) to a known delay with the output signal of the FMCW LiDAR target emulator. If the two signals differ then the emulator is using the wrong slope. The right slope sign is then determined after the emulation of one signal target in a calibration step.

FIG. 13 is a schematic diagram of an example system of a frequency discriminator using optical fibers. The LiDAR beam is sampled using the 1/99 splitter and sent to the Mach-Zehnder interferometer (MZI). Another 1/99 splitter is used to sample the emulator beam emerging from the IQ modulator.

In the schematic of the apparatus shown in FIG. 13, a Mach-Zehnder interferometer (MZI) with a path difference is utilized to provide the time delay τ and produce the reference signal. The MZI input is fed with the LiDAR's beam Tx with a pickoff beam, and one of the MZI output beams Rᵣ is then sent to a photodetector (PD). The PD output constitutes the reference signal r(t).

The Tx beam goes through the IQ modulator that emulates a target's return beam Rx at the distance required to produce a delay equal to t. A second pickoff beam is used to send the emulator beam Rx to another PD. The output of this PD constitutes the emulator signal e(t). The signals r(t) and e(t) can then be processed and compared to identify the slope of the FMCW LiDAR chirp.

An alternative scheme can be implemented to make the comparison using one PD as shown in FIG. 14. FIG. 14 illustrates a modified version of a frequency discriminator using optical fibers, where a single photodetector is used to measure the reference signal and the emulated signals. Sending both beams, Rₓ and Rᵣ, to the same PD will produce a beam with the sum of the optical paths. The signal at the PD will be the result of a single target if the slope's sign used in the emulator is correct.

FIG. 15 illustrates measurements used to determine the sign of the chirp slope, according to some embodiments. FIG. 15 shows the linear up and down chirp frequency versus time and the derivative of FFT of the PD signal for the right and wrong slope sign of the emulated chirp.

Knowledge of the frequency chirp profiles and the delay introduced by the emulator path, To, may be used to properly determine the sign of the slope. These parameters may be measured using the same setup used to determine the chirp slope sign. In the example illustrated in FIG. 15, it is assumed that the up and down frequency chirps are symmetric and linear. However, the described methods may be applied to asymmetric and/or non-linear chirps as well.

In some embodiments, a slope sign is assumed, and the IQ modulation signals u_{I}(t) and u_{Q}(t) are produced that emulate the optical signal for the delay τ. The heterodyne demodulated PD reference signal r(t) and the PD emulator signal e(t) are simultaneously acquired, and the cross-correlation of r(t) and e(t) is computed. If the cross-correlation is a maximum for t=τ₀, then the choice of slope sign was correct. If not, the opposite sign to what was assumed is correct.

FIG. 15 illustrates IQ modulator frequency synthesis for both correct and incorrect up-down frequency chirps. If the wrong slope is selected, FFT will have two peaks instead of one. One peak will come from the MZI path with the delay line and the other from the MZI with the I/Q modulator.

For the case of a single PD that measures both r(t) and e(t), a slope sign is assumed, and the IQ modulation signals u_{I}(t) and u_{Q}(t) that emulate the optical signal for the delay τ are produced. The heterodyne demodulated PD signal s (t) containing the sum of r(t) and emulator signal e(t) is measured by the single PD, the FFT of s (t) is computed, and the peak amplitude is determined. Subsequently, the assumed slope sign is flipped and the process is repeated. The two peak amplitudes are compared, and the higher amplitude peak of the FFT corresponds to the correct chirp slope sign.

### Calibration Procedure

In some embodiments, a calibration procedure may be applied to properly determine the emulator delay τ₀ and the chirp frequency profile and improve the accuracy and robustness of the frequency discriminator. The chirp profile measurement may be performed first before completing the calibration procedure.

The chirp frequency profile of the FMCW LiDAR (DUT) may be measured using the MZI according to the following steps. First, the heterodyne demodulated PD reference signal r(t) is acquired. Next, the power spectral density R(f, t) of r(t) is computed by shifting the time window across the chirp up and down time period. Finally, the peak amplitude A(t) created by the delay τ in R(f, t) is determined, which approximates the slope of the DUT chirp frequency profile.

Once the chirp frequency profile of the DUT has been measured, the delay, τ₀, introduced by the emulator path may be measured. First, the IQ modulation signals u_{I}(t) and u_{Q}(t) that emulate the optical signal for the nominal delay τ are produced sing the measured chirp frequency profile. Next, the delay τ is varied to find the delay τ* such that the emulator PD signal is maximized. Finally, the delay difference between the nominal delay τ and τ* is determined, which corresponds to τ₀.

Capturing Scanning Laser into a SM PM Fiber

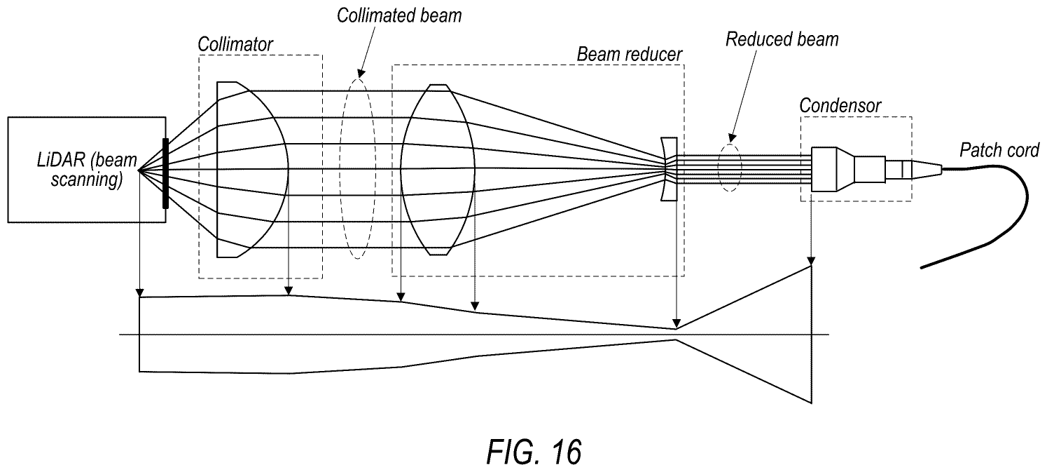

In some embodiments, the method of collecting a beam which is rotating about an arbitrary axis (for example by means of a rotating mirror) can be understood by considering this system in the paraxial regime approximation of geometrical optics. For example, FIG. 16 illustrates the path of the optical rays generated by the LiDAR UUT through the LiDAR scanner. FIG. 16 illustrates an optical system designed to place a scanning light beam into an optical fiber. For the sake of illustration, consider an ideal lens L_{I} placed at a distance from the axis of the rotating mirror equal to its focal length, fₗ, and with its optical axis perpendicular to the rotation axis. Neglecting any form of aberration, the lens will focus the optical ray emerging from the mirror to infinity.

A demagnifying afocal optical system, such as a Beam Reducing Telescope (BRT), added after L_{I} will reduce the distance of the emerging rays from the lens optical axis by a demagnification factor m(m<<1). A sufficiently large distance reduction will allow use of a beam condenser to focus the beam on the input of the optical fiber. Provided that the beam can be properly focused on the fiber input, the smaller the demagnification m, the larger the amount of light that will be collected into the fiber.

Overfilling the input of the optical fiber with the focused beam will reduce the dependence from the radial beam translation from the optical axis and increase the translation dynamic range. The downside of such an approach is the reduction of the optical power coupled into the fiber.

### Single Mode Fiber Taper Collector

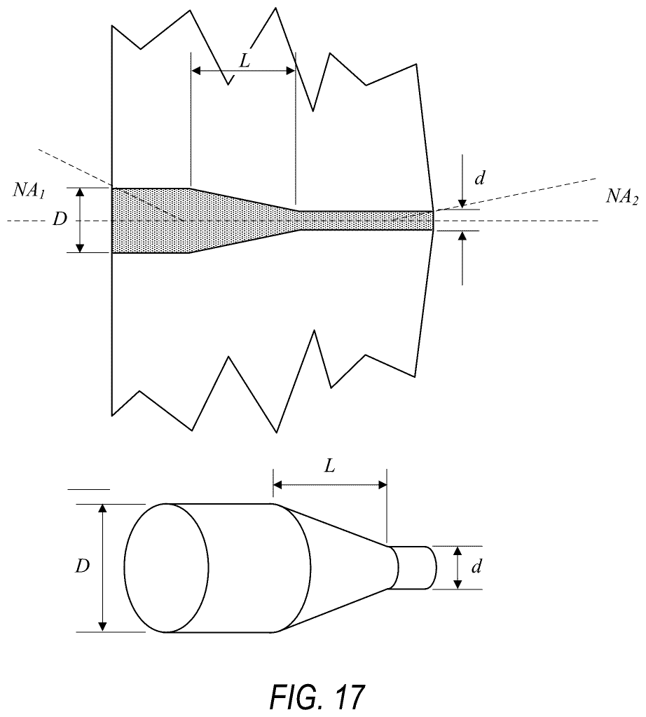

FIG. 17 illustrates a tapered optical fiber that may be used to increase the amount of light collected into the fiber, according to some embodiments. As illustrated, the beam is injected from the larger diameter side of the taper core and guided into the section of smaller diameter. The smaller diameter side is then spliced with the optical fiber.

By injecting the light from the taper side with a larger numerical aperture NA_{I}, the effect is twofold. First, rays with larger angles will couple into the fiber because of the larger numerical aperture. Consequently, rays further away which are focused by the Beam Condenser will be also coupled into the fiber. Second, beams with larger spot diameters will couple into the fiber because of the large Mode Field Diameter of the fiber. A beam with a larger translation will be also coupled into the fiber.

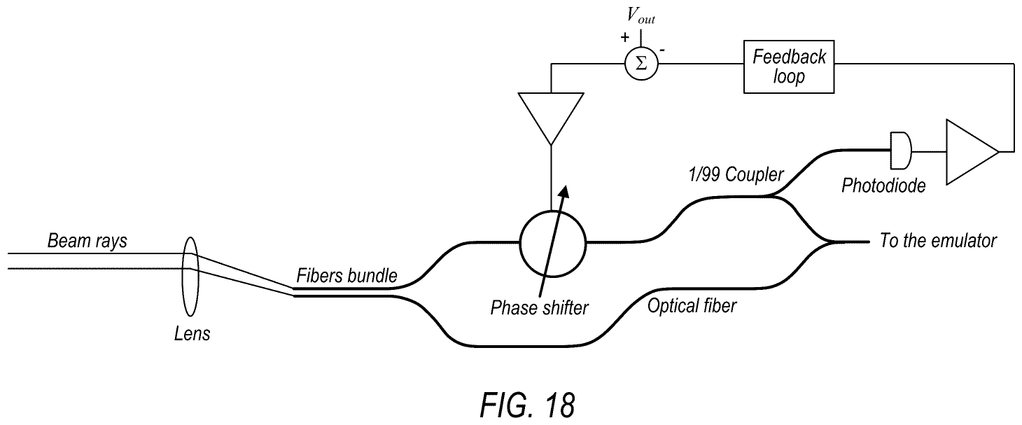

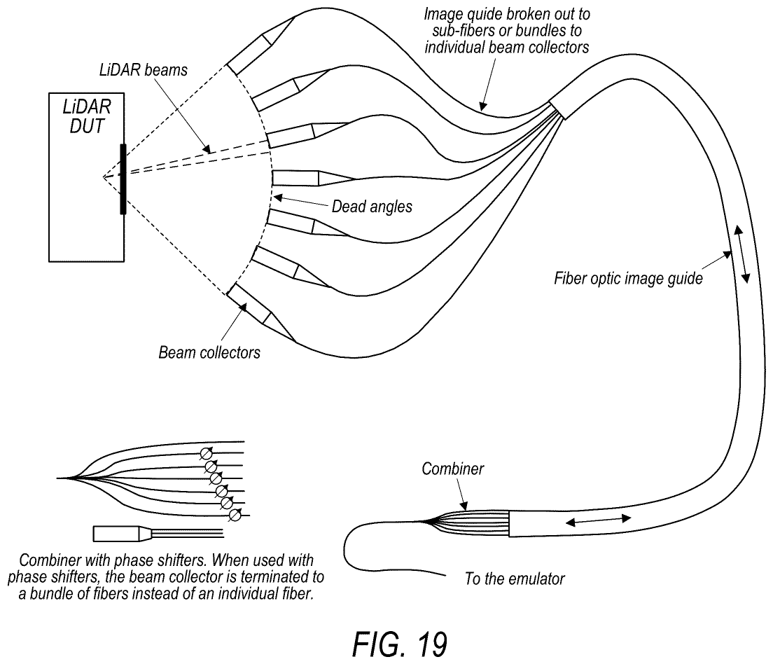

### FIGS. 18-19—Multiple Optical Paths Collection

To capture a wider field of view, multiple radial optical paths around the LiDAR may be used as shown in FIG. 19, according to some embodiments. Placing a beam collector in each one of those paths and merging the fiber ends with a multiple optical fiber coupler may overcome the field-of-view limitations of the single beam collector and extend the field of view covered by the emulator. The drawback of such a solution is the introduction of dead coupling angles due to the gaps between the beam collectors.

FIG. 18 illustrates a lens and fiber-optic cable system including multiple paths, according to some embodiments. Only one extra path is shown in FIG. 18 for the sake of simplicity, but it is within the scope of the present disclosure for the fibers bundle to contain a larger number of paths. The path without the phase shifter is the reference path, and the other path length differences are nulled against the reference path.

In some embodiments, multiple paths are implemented as show in FIG. 18. A bundle of fibers with one end at the beam condenser output will allow collection of light distributed over several optical fiber inputs. Those paths are then combined into one single fiber and sent to the target emulator optical fiber. To maintain coherence, optical path differences between the paths may be compensated for. This compensation is done by introducing a phase shifter in each path and providing a low frequency feedback (1 Hz BW approximately) to maintain the constructive interference of the combined beams. When the coupler 1% port (port A), output power is minimized, the 99% port (port B) output power is maximized. A photodiode is placed at port A to extract the error signal to keep port B output power maximized. A constant signal is sent to the phase shifter as a set point. The error signal is computed by multiplying the photodiode signal by its derivative to extend the dynamic range of the error signal. The error signal is then filtered to ensure the loop stability and added to set point of the phase shifter actuator to close the loop.

### Diverging Effect Optical System

The demagnification factor may be limited by the focusing effect of each lens of the optical system. Assuming that the beam impinging into the optical system is collimated, the effect of the first lens will be to focus the beam at the lens' focal length f₁. The following lenses of the BRT will have a similar effect. The max collection angle, θₘₐₓ, that the beam axis can rotate determines the focal length f₁:

$${f}_{1} = {D}_{2} arc tan {θ}_{max} ,$$

where D is the lens aperture. A collimated gaussian beam of waist w₀, will be focused to a new waist w₁ and its divergence will be

$${θ}_{∞ , L 1} = {w}_{0} {f}_{1} .$$

Increasing the collection angle by decreasing f₁ increases the divergence of the emerging beam. Because the beam must go through the BRT, the divergence further increases by the inverse of the demagnification factor m

$${θ}_{∞ , BRT} = {w}_{0} {f}_{1} m .$$

Supposing that f₁ and w₀ are set by LiDAR under test, the demagnification factor, m, becomes the limited maximum divergence that may be tolerated to focus the beam into the optical fiber input with the waist size equals to the radius of the of the fiber mode.

FIG. 19 illustrates a beam collector array aggregated into an optical image guide. Phase shifters may be used prior to the combiner to increase the field of view and flatten the response of each beam collector. The whole beam collectors array apparatus may be composed of several beam collector systems radially placed around the LiDAR unit as shown in FIG. 19, in some embodiments. Each beam system which is placed between the LiDAR beam output and each optical fiber that is coupled into the target emulator may be composed of three sequential centered optical subsystems, a beam collimator, a beam reducer, a beam condenser and a fiber optical taper (optional).

In some embodiments, the beam collimator transforms the beam radial rays emerging from the LiDAR into beams parallel to the optical axis of the beam collimator. In various embodiments, this collimator can be implemented by a complex optical system or by a single lens. Its effective focal length point may be placed on the point of intersection of the radial rays. Paraxial rays emerging from the beam collimator may then be focused to infinity. Marginal rays may also be focused to infinity if the system is corrected from aberration.

The parallel rays may then go through the beam reducer optical system which will translate the rays closer to the optical axis. The parallel rays will be focused into the fiber by the beam condenser optical system. The optional tapered fiber may increase the amount of coupled light for large input beam angles because of the large translation of the rays incident into the beam condenser. The ray's residual distance from the optical axis may reduce the amount of optical power coupling into the fiber. An optical fiber coupler may finally combine all the beam condensers into one single fiber which may be spliced with the emulator optical fiber. Advantageously, the use of an optical image guide preserves the field of view at the image guide output, allowing the apparatus to be used with time-of-flight LiDAR units by changing the emulator behind it.

Beam Collector with Beam Characterization System

FIG. 20 illustrates a system diagram of an optical train emulator combined with a beam characterization system, according to some embodiments. The illustrated system includes four subsystems, a beam collector (BC), a beam position and divergence pick-off (BPDP), a beam trigger pick-off (BTP), and an out-of-field beam dump (OFBD). The optical system of the LiDAR emulator targets can integrate a laser beam characterization system to provide the functionalities to qualify a FMCW LiDAR system. The beam characterization system can be connected to any of the beam collectors of the array. The subsystems of the combined system are described in the following paragraphs.

The Beam Collector (BC) collects the DUT scanned emerging beam and couple into the SM fiber of the LiDAR target emulator. The BC may be divided into the following subsystems: a beam Collimator Lens (BCL) that transforms scanned rays into collimated rays, a Beam Reducing Telescope (BRT) that reduces the diameter of the collimated rays' bundle, and a Fiber Coupler (FC) that couples the ray bundle into a SM fiber.

The Beam Position and Divergence Pick-Off (BPDP) is responsible for setting the proper beam spot diameter to determine the divergence, elevation, and azimuth of the DUT beam. The BPDP may be divided into the following subsystems: a Pick-Off Mirror (POM) that samples the beam and steers it into the delay line, a Divergence-Tuning Lens (DTL) that adjusts the beam propagation to ensure that the beam is in far field propagation once it reaches the transmission screen for the first time, and a Delay Line (DL) that propagates the beam in the far field allowing to image three beam transverse distribution on the transmission screen.

The Beam Trigger Pick-off (BTP) focuses the beam into the Trigger Photodiode which provides the sync signal with the FMCW laser frequency chirp-up-down.

The Out of Field Beam Dump (OFBD) reduces the out-of-the-field-of-view beam scattering back into the LiDAR UUT.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for emulating an over-the-air environment for testing a light detection and ranging (LiDAR) unit under test (UUT), the method comprising:
receiving, via an optical lens system, a frequency-modulated continuous wave (FMCW) laser signal transmitted by the LiDAR UUT;
providing the FMCW laser signal to an optical guidance system;
determining a slope, a chirp timing and an intensity of the FMCW laser signal;
determining, based at least in part on the slope, the chirp timing, and the intensity of the FMCW laser signal, a modulation waveform to emulate the over-the-air environment;
modulating, by an in-phase quadrature-phase (IQ) modulator, a first signal based at least in part on the modulation waveform to produce a modulated laser signal, wherein the first signal is based on the FMCW laser signal; and
transmitting the modulated laser signal through the optical lens system to the LiDAR UUT.

2. The method of claim 1,
wherein the over-the-air environment comprises a propagation environment and at least one target comprising a rough surface, an irregular target, or an oblique surface,
wherein emulating the over-the-air environment comprises emulating the at least one target by determining the modulation waveform to produce a modulation to spread a spectral distribution of the first signal.

3. The method of claim 1,
wherein the over-the-air environment comprises multiple targets,
wherein emulating the over-the-air environment comprises determining the modulation waveform to emulate respective reflections from each of the multiple targets.

4. The method of claim 3,
wherein determining the modulation waveform to emulate the respective reflections from each of the multiple targets comprises performing a summation over IQ components for each of the respective reflections.

5. The method of claim 1,
wherein determining the modulation waveform to emulate the over-the-air environment comprises:
receiving LiDAR scanning data from a physical over-the-air environment and determining frequency offset waveforms or equivalent IQ waveforms from the LiDAR scanning data.

6. The method of claim 1,
wherein determining the slope, the chirp timing and the intensity of the FMCW laser signal comprises:
splitting the FMCW lase signal into the first signal, a second signal and a third signal;
routing the second signal to a frequency discriminator to determine the slope and the chirp timing of the FMCW laser signal; and
routing the third signal to a power detector to measure the intensity of the received light.

7. The method of claim 6,
wherein determining the slope and the chirp timing of the FMCW laser signal further comprises:
splitting the second signal into a fourth signal and a fifth signal;
routing the fourth signal through a delay line;
routing the fifth signal through an acousto-optic modulator;
recombining the fourth signal and the fifth signal after routing them through the delay line and the acousto-optic modulator, respectively;
receiving the recombined fourth and fifth signal by a photodiode; and
analyzing, by a radio frequency discriminator, the recombined further and fifth signal received by the photodiode to determine the slope and the chirp timing of the FMCW laser signal.

8. The method of claim 6,
wherein determining the slope and the chirp timing of the FMCW laser signal further comprises:
splitting the second signal into a fourth, fifth, sixth and seventh signal;
routing the fourth signal through a delay line to apply a delay;
combining and measuring the fourth and fifth signals after routing the fourth signal through the delay line to obtain a reference signal;
routing the seventh signal through an in-phase quadrature (IQ) modulator, wherein the IQ modulator emulates the delay applied by the delay line; and
combining and measuring the sixth and seventh signals after applying the IQ modulator.

9. The method of claim 1, further comprising:
prior to providing the FMCW laser signal to the optical guidance system:
splitting the FMCW laser signal into the first signal and a second signal;
providing the second signal to a beam characterization system to determine one or more of a divergence, a spot size, an elevation and an azimuth of the FMCW laser signal,
wherein the modulation waveform is determined further based at least in part on one or more of the divergence, elevation and azimuth of the FMCW laser signal.

10. The method of claim 1,
wherein determining the modulation waveform is performed in advance to compensate for latency in digital signal processing of the FMCW laser signal,
wherein determining the modulation waveform in advance is performed based on information related to a chirp pattern of the FMCW laser signal.

11. The method of claim 1, further comprising:
receiving information describing an irregular chirp pattern of the FMCW laser signal,
wherein determining the chirp slop, the chirp timing, and the intensity of the FMCW laser signal is performed based at least in part on the information describing the irregular chirp pattern.

12. The method of claim 1, further comprising:
generating, by a digital waveform generator, the modulation waveform as a digital waveform;
providing the digital waveform to a digital-to-analog convertor (DAC) to produce an analog waveform,
wherein modulating the first signal with the IQ modulator comprises modulating the first signal with the analog waveform.

13. The method of claim 1,
wherein determining the modulation waveform to emulate the over-the-air environment based at least in part on the slope and the chirp timing of the FMCW laser signal comprises:
determining whether a frequency profile of the FMCW laser signal is in an up-ramp or a down-ramp;
determining the modulation waveform to add or subtract a time delay frequency shift to a Doppler frequency shift for a target in the over-the-air environment based at least in part on whether the frequency profile of the FMCW laser signal is in the up-ramp or the down-ramp.

14. The method of claim 1,
wherein determining the modulation waveform to emulate the over-the-air environment based at least in part on the intensity of the FMCW laser signal comprises:
determining a variation in received intensity of the FMCW laser signal as a function of time; and
determining the modulation waveform to compensate for the variation in the received intensity of the FMCW laser signal as a function of time.

15. The method of claim 1,
wherein the received FMCW laser signal comprises a linear frequency up-ramp followed by a linear frequency down-ramp,
wherein modulating the first signal based at least in part on the modulation waveform comprises:
shifting the linear frequency up-ramp in a same direction as the linear frequency down-ramp to emulate a Doppler shift for a target in the over-the-air environment
shifting the linear frequency up-ramp to a lower frequency and shifting the linear frequency down-ramp to a higher frequency to emulate a time delay frequency shift for the target in the over-the-air environment.

16. A system for emulating an over-the-air environment for testing a light detection and ranging (LiDAR) unit under test (UUT), the system comprising:
a processor coupled to a non-transitory computer-readable memory medium;
an in-phase quadrature-phase (IQ) modulator;
a lens system configured to receive a frequency-modulated continuous wave (FMCW) laser signal from the LiDAR UUT; and
an optical guidance system coupled to the lens system and configured to receive the FMCW laser signal from the LiDAR UUT through the lens system, wherein the system is configured to:
determine a slope, a chirp timing and an intensity of the FMCW laser signal;
determine, based at least in part on the slope, the chirp timing, and the intensity of the FMCW laser signal, a modulation waveform to emulate the over-the-air environment;
modulate, by the IQ modulator, a first signal based at least in part on the modulation waveform to produce a modulated laser signal, wherein the first signal is based on the FMCW laser signal; and
transmit the modulated laser signal through the optical lens system to the LiDAR UUT.

17. The system of claim 16,
wherein the over-the-air environment comprises multiple targets and a propagation environment,
wherein emulating the over-the-air environment comprises determining the modulation waveform to emulate respective reflections from each of the multiple targets.

18. The system of claim 16,
wherein, in determining the modulation waveform to emulate the over-the-air environment based at least in part on the slope and the chirp timing of the FMCW laser signal, the system is configured to:
determine whether a frequency profile of the FMCW laser signal is in an up-ramp or a down-ramp;
determine the modulation waveform to add or subtract a Doppler frequency shift for a velocity of a target in the over-the-air environment based at least in part on whether the frequency profile of the FMCW laser signal is in the up-ramp or the down-ramp.

19. The system of claim 16,
wherein the optical guidance system comprises one of:
one or more optical fibers,
optical waveguides in a photonic integrated circuit;
dielectric light guides; or
a free space optical circuit.

20. A non-transitory computer-readable memory medium comprising program instructions that, when executed by a processor, cause a LiDAR emulation system to:
receive, by an optical guidance system coupled to a lens system, a frequency-modulated continuous wave (FMCW) laser signal from a LiDAR UUT through the lens system;
determine a shape and an intensity of the FMCW laser signal;
determine, based at least in part on the shape and the intensity of the FMCW laser signal, a modulation waveform to emulate an over-the-air environment;
modulate, by the IQ modulator, a first signal based at least in part on the modulation waveform to produce a modulated laser signal, wherein the first signal is based on the FMCW laser signal; and
transmit the modulated laser signal through the optical lens system to the LiDAR UUT.
